(19) United States
(12) Patent Application Publication
(10) Pub. No.: US 2026/0177687 A1
(43) Pub. Date: Jun. 25, 2026

(54) POSE ESTIMATION AND ACTIVITY RECOGNITION USING RADAR

(71) Applicant: Samsung Electronics Co., Ltd., Suwon-si (KR)

(72) Inventors: Priyabrata Parida, Dallas, TX (US); Han Wang, Allen, TX (US); Hao-Hsuan Chang, Plano, TX (US); Wei Sun, Allen, TX (US); Hao Chen, Allen, TX (US)

(21) Appl. No.: 19/428,029

(22) Filed: Dec. 19, 2025

Related U.S. Application Data
(60) Provisional application No. 63/736,529, filed on Dec. 19, 2024.

(51) Int. Cl. G01S 13/89; G01S 13/58; G06N 20/00

(52) U.S. Cl. CPC G01S 13/89; G01S 13/584; G06N 20/00

(57) ABSTRACT

A method includes extracting, from each radar frame in a data stream, a set of features that a machine-learning (ML) model is configured to receive as input. The method includes detecting human presence for a current frame. The method includes in response detecting the human is present: inputting the set of features into the ML model that is configured to estimate a pose of the human based on learned spatial relationships among a set of different human body parts and a learned temporal variations of the different human body parts across multiple time instances. The method includes accumulating a queue of Nᵥ consecutive frames; and selecting a set of activity frames corresponding to a single action, based on motion features extracted from the queue. The method includes inferring and labeling a user action based on a sequence of respective poses of the human corresponding to the set of activity frames.

### CROSS-REFERENCE TO RELATED APPLICATION(S) AND CLAIM OF PRIORITY

This application claims priority under 35 U.S.C. § 119 (e) to U.S. Provisional Patent Application No. 63/736,529 filed on Dec. 19, 2024. The above-identified provisional patent application is hereby incorporated by reference in its entirety.

### TECHNICAL FIELD

This disclosure relates generally to radar systems. More specifically, this disclosure relates to pose estimation and activity recognition using radar.

### BACKGROUND

Ambient sensing has been popularized recently. A system performs ambient sensing by gathering information from a multitude of sensors and using contextual information to draw useful insights. The system can take subsequent actions, based on results of the ambient sensing, to achieve certain goals by making suitable changes to an operational environment. One such paradigm of ambient sensing is for wellness care in which a goal is to improve comfort, safety, and well-being of people living in a home environment. The wellness care ambient sensing may use various sensors (such as microphones, millimeter (mm) Wave radar, Wi-Fi chips, Bluetooth chips, etc.) found in a typical home environment to gather information.

### SUMMARY

This disclosure provides pose estimation and activity recognition using radar.

In one embodiment, a method for using mmWave radar for estimating a human pose and performing activity recognition is provided. The method includes extracting, from each radar frame in a stream of radar data, a set of features that a machine-learning (ML) model is configured to receive as input. The method includes determining whether a human is present for a current frame in the stream based on a range profile of the current frame. The method includes in response to a determination that the human is present for the current frame: inputting the set of features for the current frame into the ML model. The ML model is configured to estimate a pose of the human based on learned spatial relationships among a set of different human body parts and a learned temporal variations of the different human body parts across multiple time instances. The pose of the human includes a set of spatial relationships among the set of different human body parts at the current frame. The method includes in response to a determination that the human is present for the current frame: accumulating the current frame and past consecutive radar frames from the stream into a queue of Nᵥ. The method includes segmenting the stream into non-activity frames and a set of activity frames corresponding to a single action, based on motion features extracted from the queue. The method includes triggering an activity recognizer that is trained to infer a user action based on a sequence of respective poses of the human corresponding to the set of activity frames. The method includes obtaining and outputting a label for the inferred user action.

In another embodiment, a system for using mmWave radar for estimating a human pose and performing activity recognition is provided. The system includes a transceiver and a processor operably connected to the transceiver. The processor is configured to extract, from each radar frame in a stream of radar data, a set of features that a machine-learning (ML) model is configured to receive as input. The processor is configured to determine whether a human is present for a current frame in the stream based on a range profile of the current frame. The processor is configured to in response to a determination that the human is present for the current frame: input the set of features for the current frame into the ML model. The ML model is configured to estimate a pose of the human based on learned spatial relationships among a set of different human body parts and a learned temporal variations of the different human body parts across multiple time instances. The pose of the human includes a set of spatial relationships among the set of different human body parts at the current frame. The processor is configured to in response to a determination that the human is present for the current frame: accumulate the current frame and past consecutive radar frames from the stream into a queue of Nᵥ. The processor is configured to segment the stream into non-activity frames and a set of activity frames corresponding to a single action, based on motion features extracted from the queue. The processor is configured to trigger an activity recognizer that is trained to infer a user action based on a sequence of respective poses of the human corresponding to the set of activity frames. The processor is configured to obtain and output a label for the inferred user action.

In yet another embodiment, a non-transitory computer readable medium comprising program code for using mmWave radar for estimating a human pose and performing activity recognition is provided. The computer program includes computer readable program code that when executed causes at least one processor to extract, from each radar frame in a stream of radar data, a set of features that a machine-learning (ML) model is configured to receive as input. The computer readable program code causes the processor to determine whether a human is present for a current frame in the stream based on a range profile of the current frame. The computer readable program code causes the processor to in response to a determination that the human is present for the current frame: input the set of features for the current frame into the ML model. The ML model is configured to estimate a pose of the human based on learned spatial relationships among a set of different human body parts and a learned temporal variations of the different human body parts across multiple time instances. The pose of the human includes a set of spatial relationships among the set of different human body parts at the current frame. The computer readable program code causes the processor to, in response to a determination that the human is present for the current frame: accumulate the current frame and past consecutive radar frames from the stream into a queue of Nᵥ. The computer readable program code causes the processor to segment the stream into non-activity frames and a set of activity frames corresponding to a single action, based on motion features extracted from the queue. The computer readable program code causes the processor to trigger an activity recognizer that is trained to infer a user action based on a sequence of respective poses of the human corresponding to the set of activity frames. The computer readable program code causes the processor to obtain and output a label for the inferred user action.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Definitions for other certain words and phrases may be provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example network configuration including an electronic device according to this disclosure;

FIG. 2 illustrates an example electronic device in accordance with an embodiment of this disclosure;

FIG. 3 illustrates a three-dimensional view of an example electronic device that includes multiple millimeter wave (mmWave) antenna modules in accordance with an embodiment of this disclosure;

FIG. 4 illustrates an example architecture of a monostatic radar in an electronic device in accordance with an embodiment of this disclosure;

FIG. 5 illustrates a mmWave monostatic frequency-modulated continuous wave (FMCW) transceiver system in accordance with an embodiment of this disclosure;

FIG. 6 illustrates a frame-based radar transmission timing structure in accordance with an embodiment of this disclosure;

FIG. 7 illustrates a block diagram of an ambient wireless sensing system in accordance with an embodiment of this disclosure;

FIG. 8 illustrates a block diagram of a system implementing a process for human pose and activity estimation using mmWave radar in accordance with an embodiment of this disclosure;

FIG. 9 illustrates a method for human presence detection accordance with an embodiment of this disclosure;

FIG. 10 illustrates a human pose estimator that includes a pointcloud extractor and a recurrent neural network based (RNN-based) model architecture in accordance with an embodiment of this disclosure;

FIG. 11 illustrates a human pose estimator that includes transformer-based model architecture in accordance with an embodiment of this disclosure;

FIG. 12 illustrates a human pose estimator that includes an RNN-based model architecture without a pointcloud extractor in accordance with an embodiment of this disclosure;

FIG. 13 illustrates a three-layered CNN architecture used for generating embeddings from RDM, RAM, and REM in a human pose estimator in accordance with an embodiment of this disclosure;

FIG. 14 illustrates the convolutional neural network (CNN) of FIG. 13 in accordance with an embodiment of this disclosure;

FIG. 15 illustrates a method for activity segmentation in accordance with an embodiment of this disclosure;

FIG. 16 illustrates an operation of a vision language model based (VLM-based) zero-shot activity segmenter in accordance with an embodiment of this disclosure;

FIG. 17 illustrates a process for local nominal-shot activity recognition in accordance with an embodiment of this disclosure;

FIG. 18 illustrates a process for retraining the local nominal-shot activity recognizer based on an unseen class in accordance with an embodiment of this disclosure;

FIGS. 19A-19G illustrate examples of a plot of a ground truth skeleton and a corresponding plot of a radar-based predicted skeleton in accordance with an embodiment of this disclosure; and

FIG. 20 illustrates a method for human pose estimation and activity recognition using mm Wave radar in accordance with an embodiment of this disclosure.

### DETAILED DESCRIPTION

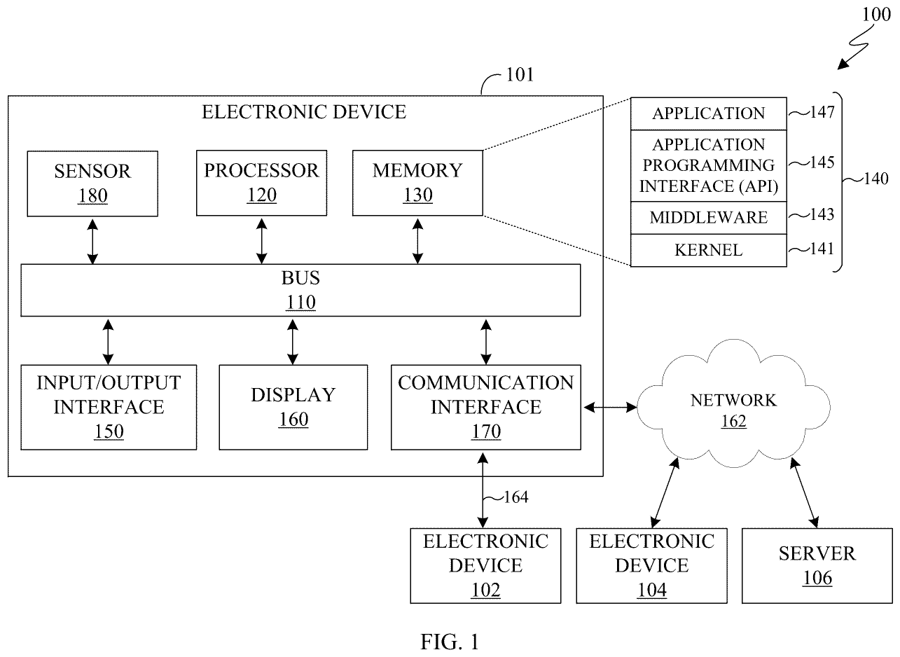

FIGS. 1 through 20, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged wireless communication system or device.

There are two basic elements of accurate human activity recognition (HAR): pose estimation at a given time instance and variation of human pose over time. For accurate human pose estimation (HPE), this disclosure provides a system that captures the spatial dependencies among different body parts at any given time instance. This disclosure further provides a technique to accurately capture the temporal changes in human body parts to get an accurate indication of the action performed by the user. Although radars provide superior spatial resolution in the radial axis and Doppler resolution to track the target velocity, radars have a significantly lower resolution in the angular domains (such as the azimuth domain and elevation domain). The limited resolution in the angular domains makes the pose estimation task challenging for radars. Within embodiments according to disclosure, a sophisticated machine learning (ML)-model architecture has been designed to utilize any suitable information from the radial, angular, and Doppler domains while neglecting the noisy contributions from the environment.

Further, for activity recognition, it is not feasible to train a model that can accurately identify any action performed by the user due to the large set of actions that can be performed in a home environment. As a technical solution, this disclosure provides an activity recognition system that is able to identify human actions that are out of training sets-thereby solving a problem that is difficult to solve.

This disclosure provides various embodiments for pose estimation and action recognition using mmWave radar. For example, this disclosure provides an end-to-end framework for human activity recognition (HAR) using mmWave radar that includes a feature extraction module, a presence detection module, a pose estimator, an activity segmentation module, and an activity recognition module. Additionally, this disclosure provides a spatio-temporal ML-based pose estimation module that captures the spatial relationship among different human body parts at a given time instance as well as the temporal variation of specific body parts across multiple time instances. Further, this disclosure provides a signal processing-based activity segmentation module that separates activity frames from a sequence of consecutive frames using information such as the average speed of the human body parts at each time instant. As another example, this disclosure provides an ML-based one-shot activity recognition module that is suitable for in-the-wild inference of unseen activities. The activity recognition module can use a large language model based (LLM-based) zero-shot and ML-based nominal-shot (for example one-shot or few-shot) to perform activity recognition for inference on unseen activities.

FIG. 1 illustrates an example network configuration 100 including an electronic device according to this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more of a central processing unit (CPU), an application processor (AP), or a communication processor (CP). The processor 120 is able to perform control on at least one of the other components of the electronic device 101 and/or perform an operation or data processing relating to communication. In some embodiments, the processor 120 can be a graphics processor unit (GPU). As described in more detail below, the processor 120 may perform one or more operations for using mm Wave radar for estimating a human pose and performing activity recognition.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support one or more functions for using mmWave radar for estimating a human pose and performing activity recognition as discussed below. These functions can be performed by a single application or by multiple applications that each carry out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a cellular communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

The first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can be accessed by one or more of the electronic devices 101-104 of FIG. 1 or another server, for example, via the network 162. The server 106 can support to drive the electronic device 101 by performing at least one of operations (or functions) implemented on the electronic device 101. For example, the server 106 can include a processing module or processor that may support the processor 120 implemented in the electronic device 101. The processor 210 within could be divided into multiple processors, such as one or more central processing units (CPUs) and one or more graphics processing units (GPUs). The processor within the server 106 executes instructions that can be stored in a memory of the server. The server 106 can represent one or more encoders, decoders, local servers, remote servers, clustered computers, and components that act as a single pool of seamless resources, a cloud-based server, and the like. As described in more detail below, the server 106 may perform one or more operations to support using mm Wave radar for estimating a human pose and performing activity recognition.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

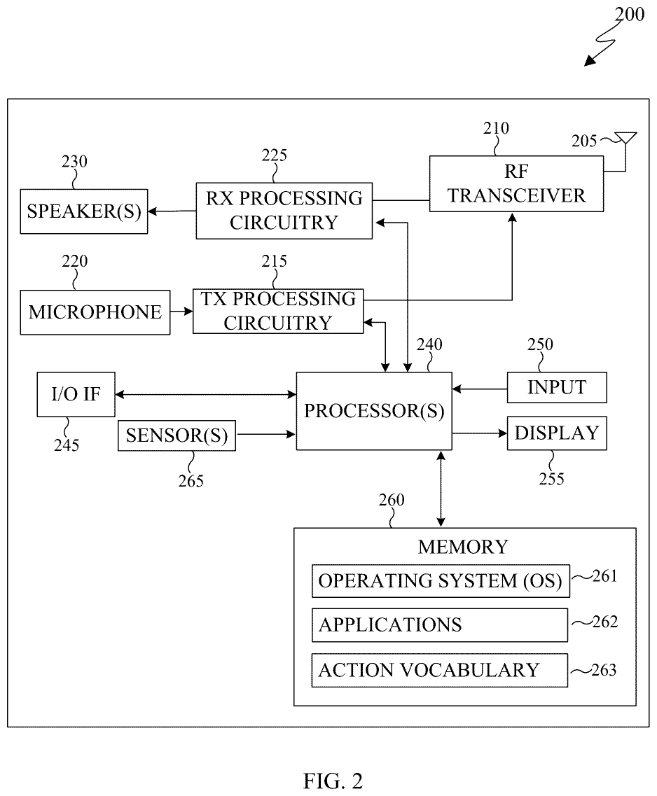

FIG. 2 illustrates an example electronic device in accordance with an embodiment of this disclosure. In particular, FIG. 2 illustrates an example electronic device 200, and the electronic device 200 could represent the server 106 or one or more of the electronic devices 101-104 in FIG. 1. The electronic device 200 can be a mobile communication device, such as, for example, a mobile station, a subscriber station, a wireless terminal, a desktop computer, a portable electronic device (similar to a mobile device, the personal digital assistant (PDA), laptop computer, or tablet computer), a robot, and the like.

As shown in FIG. 2, the electronic device 200 includes transceiver(s) 210, transmit (TX) processing circuitry 215, a microphone 220, and receive (RX) processing circuitry 225. The transceiver(s) 210 can include, for example, a RF transceiver, a BLUETOOTH transceiver, a WiFi transceiver, a ZIGBEE transceiver, an infrared transceiver, and various other wireless communication signals. The electronic device 200 also includes a speaker 230, a processor 240, an input/output (I/O) interface (IF) 245, an input 250, a display 255, a memory 260, and a sensor 265. The memory 260 includes an operating system (OS) 261, and one or more applications 262.

The transceiver(s) 210 can include an antenna array 205 including numerous antennas. The antennas of the antenna array can include a radiating element composed of a conductive material or a conductive pattern formed in or on a substrate. The transceiver(s) 210 transmit and receive a signal or power to or from the electronic device 200. The transceiver(s) 210 receives an incoming signal transmitted from an access point (such as a base station, WiFi router, or BLUETOOTH device) or other device of the network 162 (such as a WiFi, BLUETOOTH, cellular, 5G, 6G, LTE, LTE-A, WiMAX, or any other type of wireless network). The transceiver(s) 210 down-converts the incoming RF signal to generate an intermediate frequency or baseband signal. The intermediate frequency or baseband signal is sent to the RX processing circuitry 225 that generates a processed baseband signal by filtering, decoding, and/or digitizing the baseband or intermediate frequency signal. The RX processing circuitry 225 transmits the processed baseband signal to the speaker 230 (such as for voice data) or to the processor 240 for further processing (such as for web browsing data).

The TX processing circuitry 215 receives analog or digital voice data from the microphone 220 or other outgoing baseband data from the processor 240. The outgoing baseband data can include web data, e-mail, or interactive video game data. The TX processing circuitry 215 encodes, multiplexes, and/or digitizes the outgoing baseband data to generate a processed baseband or intermediate frequency signal. The transceiver(s) 210 receives the outgoing processed baseband or intermediate frequency signal from the TX processing circuitry 215 and up-converts the baseband or intermediate frequency signal to a signal that is transmitted.

The processor 240 can include one or more processors or other processing devices. The processor 240 can execute instructions that are stored in the memory 260, such as the OS 261 in order to control the overall operation of the electronic device 200. For example, the processor 240 could control the reception of downlink (DL) channel signals and the transmission of uplink (UL) channel signals by the transceiver(s) 210, the RX processing circuitry 225, and the TX processing circuitry 215 in accordance with well-known principles. The processor 240 can include any suitable number(s) and type(s) of processors or other devices in any suitable arrangement. For example, in certain embodiments, the processor 240 includes at least one microprocessor or microcontroller. Example types of processor 240 include microprocessors, microcontrollers, digital signal processors, field programmable gate arrays, application specific integrated circuits, and discrete circuitry. In certain embodiments, the processor 240 can include a neural network.

The processor 240 is also capable of executing other processes and programs resident in the memory 260, such as operations that receive and store data. The processor 240 can move data into or out of the memory 260 as required by an executing process. In certain embodiments, the processor 240 is configured to execute the one or more applications 262 based on the OS 261 or in response to signals received from external source(s) or an operator. Example, applications 262 can include a multimedia player (such as a music player or a video player), a phone calling application, a virtual personal assistant, wellness care applications, and the like.

In this disclosure, the applications 262 can include or use a vocabulary 263 of actions for performing activity recognition/labelling. The vocabulary 263 can be stored locally in the memory 260 and/or remotely in a server.

The processor 240 is also coupled to the I/O interface 245 that provides the electronic device 200 with the ability to connect to other devices, such as electronic devices 101-104. The I/O interface 245 is the communication path between these accessories and the processor 240.

The processor 240 is also coupled to the input 250 and the display 255. The operator of the electronic device 200 can use the input 250 to enter data or inputs into the electronic device 200. The input 250 can be a keyboard, touchscreen, mouse, track ball, voice input, or other device capable of acting as a user interface to allow a user to interact with the electronic device 200. For example, the input 250 can include voice recognition processing, thereby allowing a user to input a voice command. In another example, the input 250 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 250 can be associated with the sensor(s) 265, a camera, and the like, which provide additional inputs to the processor 240. The input 250 can also include a control circuit. In the capacitive scheme, the input 250 can recognize touch or proximity.

The display 255 can be a liquid crystal display (LCD), light-emitting diode (LED) display, organic LED (OLED), active-matrix OLED (AMOLED), or other display capable of rendering text and/or graphics, such as from websites, videos, games, images, and the like. The display 255 can be a singular display screen or multiple display screens capable of creating a stereoscopic display. In certain embodiments, the display 255 is a heads-up display (HUD).

The memory 260 is coupled to the processor 240. Part of the memory 260 could include a RAM, and another part of the memory 260 could include a Flash memory or other ROM. The memory 260 can include persistent storage (not shown) that represents any structure(s) capable of storing and facilitating retrieval of information (such as data, program code, and/or other suitable information). The memory 260 can contain one or more components or devices supporting longer-term storage of data, such as a read only memory, hard drive, Flash memory, or optical disc.

The electronic device 200 further includes one or more sensors 265 that can meter a physical quantity or detect an activation state of the electronic device 200 and convert metered or detected information into an electrical signal. For example, the sensor 265 can include one or more buttons for touch input, a camera, a gesture sensor, optical sensors, cameras, one or more inertial measurement units (IMUs), such as a gyroscope or gyro sensor, and an accelerometer. The sensor 265 can also include an air pressure sensor, a magnetic sensor or magnetometer, a grip sensor, a proximity sensor, an ambient light sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue (RGB) sensor), and the like. The sensor 265 can further include control circuits for controlling any of the sensors included therein. Any of these sensor(s) 265 may be located within the electronic device 200 or within a secondary device operably connected to the electronic device 200.

The electronic device 200 as used herein can include a transceiver that can both transmit and receive radar signals. For example, the transceiver(s) 210 includes a radar transceiver 270, as described more particularly below. In this embodiment, one or more transceivers in the transceiver(s) 210 is a radar transceiver 270 that is configured to transmit and receive signals for detecting and ranging purposes. For example, the radar transceiver 270 may be any type of transceiver including, but not limited to a WiFi transceiver, for example, an 802.11ay transceiver. The radar transceiver 270 can operate both radar and communication signals concurrently. The radar transceiver 270 includes one or more antenna arrays, or antenna pairs, that each includes a transmitter (or transmitter antenna) and a receiver (or receiver antenna). The radar transceiver 270 can transmit signals at a various frequencies. For example, the radar transceiver 270 can transmit signals at frequencies including, but not limited to, 6 GHZ, 7 GHZ, 8 GHZ, 28 GHZ, 39 GHz, 60 GHz, and 77 GHz. In some embodiments, the signals transmitted by the radar transceiver 270 can include, but are not limited to, millimeter wave (mmWave) signals. The radar transceiver 270 can receive the signals, which were originally transmitted from the radar transceiver 270, after the signals have bounced or reflected off of target objects in the surrounding environment of the electronic device 200. In some embodiments, the radar transceiver 270 can be associated with the input 250 to provide additional inputs to the processor 240.

In certain embodiments, the radar transceiver 270 is a monostatic radar. A monostatic radar includes a transmitter of a radar signal and a receiver, which receives a delayed echo of the radar signal, which are positioned at the same or similar location. For example, the transmitter and the receiver can use the same antenna or nearly co-located while using separate, but adjacent antennas. Monostatic radars are assumed coherent such that the transmitter and receiver are synchronized via a common time reference. FIG. 4, below, illustrates an example monostatic radar.

In certain embodiments, the radar transceiver 270 can include a transmitter and a receiver. In the radar transceiver 270, the transmitter can transmit millimeter wave (mmWave) signals. In the radar transceiver 270, the receiver can receive the mmWave signals originally transmitted from the transmitter after the mmWave signals have bounced or reflected off of target objects in the surrounding environment of the electronic device 200. The processor 240 can analyze the time difference between when the mmWave signals are transmitted and received to measure the distance of the target objects from the electronic device 200. Based on the time differences, the processor 240 can generate an image of the object by mapping the various distances.

Although FIG. 2 illustrates one example of electronic device 200, various changes can be made to FIG. 2. For example, various components in FIG. 2 can be combined, further subdivided, or omitted and additional components can be added according to particular needs. As a particular example, the processor 240 can be divided into multiple processors, such as one or more central processing units (CPUs), one or more graphics processing units (GPUs), one or more neural networks, and the like. Also, while FIG. 2 illustrates the electronic device 200 configured as a mobile telephone, tablet, or smartphone, the electronic device 200 can be configured to operate as other types of mobile or stationary devices.

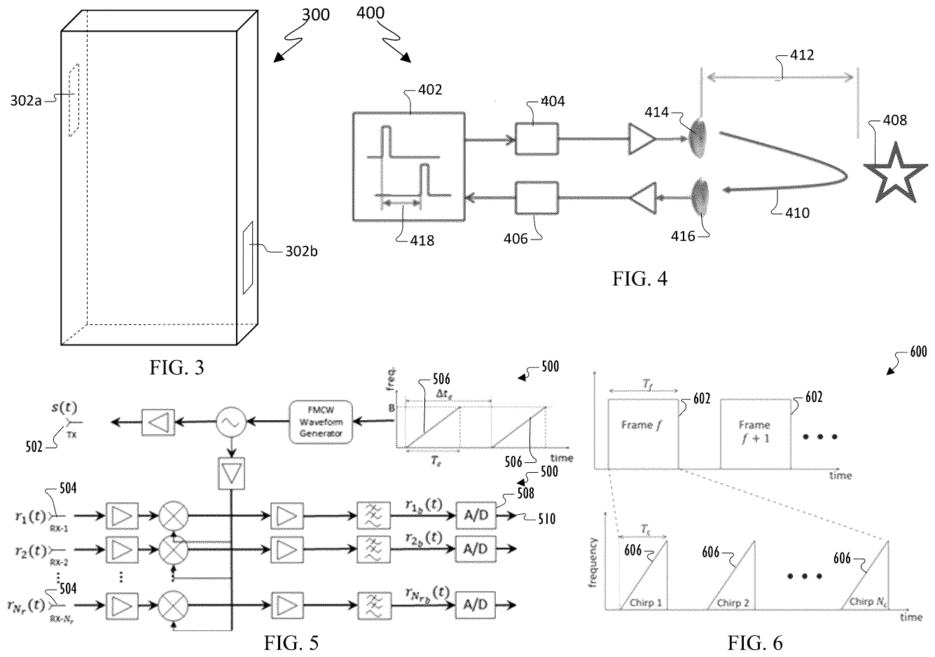

FIG. 3 illustrates a three-dimensional view of an example electronic device 300 that includes multiple millimeter wave (mmWave) antenna modules 302 in accordance with an embodiment of this disclosure. The electronic device 300 could represent one or more of the electronic devices 101-104 in FIG. 1 or the electronic device 200 in FIG. 2. The embodiments of the electronic device 300 illustrated in FIG. 3 are for illustration only, and other embodiments can be used without departing from the scope of the present disclosure.

As used herein, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

The first antenna module 302a and the second antenna module 302b are positioned at the left and the right edges of the electronic device 300. For simplicity, the first and second antenna modules 302a-302b are generally referred to as an antenna module 302. In certain embodiments, the antenna module 302 includes an antenna panel, circuitry that connects the antenna panel to a processor (such as the processor 240 of FIG. 2), and the processor.

The electronic device 300 can be equipped with multiple antenna elements. For example, the first and second antenna modules 302a-302b are disposed in the electronic device 300 where each antenna module 302 includes one or more antenna elements. The electronic device 300 uses the antenna module 302 to perform beamforming when the electronic device 300 attempts to establish a connection with a base station (for example, base station 116).

FIG. 4 illustrates an example architecture of a monostatic radar in an electronic device 400 in accordance with an embodiment of this disclosure. The embodiments of the architecture of the monostatic radar illustrated in FIG. 4 are for illustration only, and other embodiments can be used without departing from the scope of the present disclosure.

The electronic device 400 that includes a processor 402, a transmitter 404, and a receiver 406. The electronic device 400 can be similar to any of the electronic devices 101-104 of FIG. 1, the electronic device 200 of FIG. 2, or the electronic device 300 of FIG. 3. The processor 402 is similar to the processor 240 of FIG. 2. Additionally, the transmitter 404 and the receiver 406 can be included within the radar transceiver 270 of FIG. 2. The radar can be used to detect the range, velocity and/or angle of a target object 408. Operating at mm Wave frequency with GHz of bandwidth (e.g., 2, 3, 5 or 7 GHz bandwidth), the radar can be useful for applications such as proximity sensing, gesture recognition, liveness detection, mmWave blockage detection, and so on.

The transmitter 404 transmits a signal 410 (for example, a monostatic radar signal) to the target object 408. The target object 408 is located a distance 412 from the electronic device 400. In certain embodiments, the target object 408 corresponds to the objects that form the physical environment around the electronic device 400. For example, the transmitter 404 transmits a signal 410 via a transmit antenna 414. The signal 410 reflects off the target object 408 and is received by the receiver 406 as a delayed echo, via a receive antenna 416. The signal 410 represents one or many signals that can be transmitted from the transmitter 404 and reflected off the target object 408. The processor 402 can identify the information associated with the target object 408 based on the receiver 406 receiving the multiple reflections of the signals.

The processor 402 analyzes a time difference 418 from when the signal 410 is transmitted by the transmitter 404 and received by the receiver 406. The time difference 418 is also referred to as a delay, which indicates a delay between the transmitter 404 transmitting the signal 410 and the receiver 406 receiving the signal after the signal is reflected or bounced off the target object 408. Based on the time difference 418, the processor 402 derives the distance 412 between the electronic device 400, and the target object 408. The distance 412 can change when the target object 408 moves while electronic device 400 is stationary. The distance 412 can change when the electronic device 400 moves while the target object 408 is stationary. Also, the distance 412 can change when the electronic device 400 and the target object 408 are both moving. As described herein, the electronic device 400 that includes the architecture of a monostatic radar is also referred to as a radar 400.

The signal 410 can be a radar pulse as a realization of a desired “radar waveform,” modulated onto a radio carrier frequency. The transmitter 404 transmits the radar pulse signal 410 through a power amplifier and transmit antenna 414, either omni-directionally or focused into a particular direction. A target (such as target 408), at a distance 412 from the location of the radar (e.g., location of the transmit antenna 414) and within the field-of-view of the transmitted signal 410, will be illuminated by RF power density pₜ (in units of W/m2) for the duration of the transmission of the radar pulse. Herein, the distance 412 from the location of the radar to the location of the target 408 is simply referred to as “R” or as the “target distance.” To first order, pₜ can be described by Equation 1, where P_{T} represents transmit power in units of watts (W), G_{T} represents transmit antenna gain in units of decibels relative to isotropic (dBi), A_{T} represents effective aperture area in units of square meters (m2), and λ represents wavelength of the radar signal RF carrier signal in units of meters. In Equation 1, effects of atmospheric attenuation, multi-path propagation, antenna losses, etc. have been neglected.

$${p}_{t} = \frac{{P}_{T}}{4 π {R}^{2}} {G}_{T} = \frac{{P}_{T}}{4 π {R}^{2}} \frac{{A}_{T}}{( {λ}^{2} / 4 π )} = {P}_{T} \frac{{A}_{T}}{{λ}^{2} {R}^{2}} \qquad ( 1 )$$

The transmit power density impinging onto the surface of the target will reflect into the form of reflections depending on the material composition, surface shape, and dielectric behavior at the frequency of the radar signal. Note that off-direction scattered signals are typically too weak to be received back at the radar receiver (such as receive antenna 416 of FIG. 4), so typically, only direct reflections will contribute to a detectable receive signal. In essence, the illuminated area(s) of the target with normal vectors pointing back at the receiver will act as transmit antenna apertures with directivities (gains) in accordance with corresponding effective aperture area(s). The power of the reflections, such as direct reflections reflected and received back at the radar receiver, can be described by Equation 2, where P_{refl} represents effective (isotropic) target-reflected power in units of watts, Aₜ represents effective target area normal to the radar direction in units of m2, Gₜ represents corresponding aperture gain in units of dBi, and RCS represents radar cross section in units of square meters. Also in Equation 2, rₜ represents reflectivity of the material and shape, is unitless, and has a value between zero and one inclusively ([0, . . . , 1]). The RCS is an equivalent area that scales proportional to the actual reflecting area-squared, inversely proportional with the wavelength-squared, and is reduced by various shape factors and the reflectivity of the material itself. For a flat, fully reflecting mirror of area Aₜ, large compared with λ2,

$$R C S = 4 π {A}_{t}^{2} / {λ}^{2} .$$

$${P}_{refl} = {p}_{t} {A}_{t} {G}_{t} ∼ {p}_{t} {A}_{t} {r}_{t} \frac{{A}_{t}}{( {λ}^{2} / 4 π )} = {p}_{t} RCS \qquad ( 2 )$$

The target-reflected power (P_{R}) at the location of the receiver results from the reflected-power density at the reverse distance R, collected over the receiver antenna aperture area. For example, the target-reflected power (P_{R}) at the location of the receiver can be described by Equation 3, where A_{R} represents the receiver antenna effective aperture area in units of square meters. In certain embodiments, A_{R} may be the same as A_{T}.

$${P}_{R} = \frac{{P}_{refl}}{4 π {R}^{2}} {A}_{R} = {P}_{T} \cdot RCS \frac{{A}_{T} {A}_{R}}{4 {πλ}^{2} {R}^{4}} \qquad ( 3 )$$

The target distance R sensed by the radar 400 is usable (for example, reliably accurate) as long as the receiver signal exhibits sufficient signal-to-noise ratio (SNR), the particular value of which depends on the waveform and detection method used by the radar 500 to sense the target distance. The SNR can be expressed by Equation 4, where k represents Boltzmann's constant, T represents temperature, and kT is in units of W/Hz]. In Equation 4, B represents bandwidth of the radar signal in units of Hertz (Hz), F represents receiver noise factor. The receiver noise factor represents degradation of receive signal SNR due to noise contributions of the receiver circuit itself.

$$SNR = \frac{{P}_{R}}{kT \cdot B \cdot F} \qquad ( 4 )$$

If the radar signal is a short pulse of duration T_{P} (also referred to as pulse width), the delay τ between the transmission and reception of the corresponding echo can be expressed according to Equation 5, where c is the speed of (light) propagation in the medium (air).

$$τ = 2 R / c \qquad ( 5 )$$

In a scenario in which several targets are located at slightly different distances from the radar 400, the individual echoes can be distinguished as such if the delays differ by at least one pulse width. Hence, the range resolution (ΔR) of the radar 400 can be expressed according to Equation 6.

$$Δ R = c Δτ / 2 = {cT}_{P} / 2 \qquad ( 6 )$$

If the radar signal is a rectangular pulse of duration T_{P}, the rectangular pulse exhibits a power spectral density P(f) expressed according to Equation 7. The rectangular pulse has a first null at its bandwidth B, which can be expressed according to Equation 8. The range resolution A_{R} of the radar 400 is fundamentally connected with the bandwidth of the radar waveform, as expressed in Equation 9.

$$P ( f ) ∼ {( sin ( π {fT}_{P} ) / ( π {fT}_{P} ) )}^{2} \qquad ( 7 )$$

$$B = 1 / {T}_{P} \qquad ( 8 )$$

$$Δ R = c / 2 B \qquad ( 9 )$$

Although FIG. 4 illustrates one example radar 400, various changes can be made to FIG. 4. For example, the radar 400 could include hardware implementing a monostatic radar with 5G communication radio, and the radar can utilize a 5G waveform according to particular needs. In another example, the radar 400 could include hardware implementing a standalone radar, in which case, the radar transmits its own waveform (such as a chirp) on non-5G frequency bands such as the 24 GHz industrial, scientific and medical (ISM) band. In another particular example, the radar 400 could include hardware of a 5G communication radio that is configured to detect nearby objects, namely, the 5G communication radio has a radar detection capability.

FIG. 5 illustrates a mmWave monostatic frequency-modulated continuous wave (FMCW) transceiver system 500 in accordance with an embodiment of this disclosure. The FMCW transceiver system 500 could be included in one or more of the client devices 106-114 of FIG. 1, the electronic device 200 of FIG. 2, or the electronic device 300 of FIG. 3. The transmitter and the receiver within the FMCW transceiver system 500 can be included within the radar transceiver 270 of FIG. 2. The FMCW transceiver system 500 operates as a radar that can be used to detect the range, velocity and/or angle of a target object (such as the target object 408 of FIG. 4). The embodiments of the FMCW transceiver system 500 illustrated in FIG. 5 are for illustration only, and other embodiments can be used without departing from the scope of the present disclosure.

The FMCW transceiver system 500 includes a mmWave monostatic FMCW radar with sawtooth linear frequency modulation. The operational bandwidth of the radar can be described according to Equation 10, where fₘᵢₙ and fₘₐₓ are minimum and maximum sweep frequencies of the radar, respectively. The radar is equipped with a single transmit antenna 502 and Nᵣ receive antennas 504.

$$B = {f}_{min} - {f}_{max} \qquad ( 10 )$$

The receive antennas 504 form a uniform linear array (ULA) with spacing d₀, which is expressed according to Equation 11, where λₘₐₓ represents a maximum wavelength that is expressed according to Equation 12, c is the velocity of the light.

$${d}_{0} = \frac{{λ}_{max}}{2} \qquad ( 11 )$$

$${λ}_{max} = \frac{c}{{f}_{min}} \qquad ( 12 )$$

The transmitter transmits a frequency modulated sinusoid chirp 506 of duration T_{c} over the bandwidth B. Hence, the range resolution rₘᵢₙ of the radar is expressed according to Equation 13. In the time domain, the transmitted chirp s(t) 506 is expressed according to Equation 14, where A_{T} represents the amplitude of the transmit signal and S represents a ratio that controls the frequency ramp of s(t). The ratio Sis expressed according to Equation 15.

$${r}_{min} = \frac{c}{2 B} \qquad ( 13 )$$

$$s ( t ) = {A}_{T} cos ( 2 π ( {f}_{min} t + \frac{1}{2} {St}^{2} ) ) \qquad ( 14 )$$

$$S = \frac{B}{{T}_{c}} \qquad ( 15 )$$

When the transmitted chirp s(t) 506 impinges on an object (such as a finger, hand, or other body part of a human), the reflected signal from the object is received at the Nᵣ receive antennas 504. The object is located at a distance R₀ from the radar (for example, from the transmit antenna 502). In this disclosure, the distance R₀ is also referred to as the “object range,” “object distance,” or “target distance.” Assuming one dominant reflected path, the received signal at the reference antenna can be expressed according to Equation 16, where A_{R} represents the amplitude of the reflected signal which is a function of A_{T}, distance between the radar and the reflecting object, and the physical properties of the object. Also in Equation 16, τ represents the round trip time delay to the reference antenna, and can be expressed according to Equation 17.

$$r ( t ) = {A}_{R} cos ( 2 π ( {f}_{min} ( t - τ ) + \frac{1}{2} {S ( t - τ )}^{2} ) ) \qquad ( 16 )$$

$$τ = \frac{2 {R}_{o}}{c} \qquad ( 17 )$$

The beat signal r_{b(t)} for the reference antenna is obtained by low pass filtering the output of the mixer. For the reference antenna, the beat signal is expressed according to Equation 18, where the last approximation follows from the fact that the propagation delay is orders of magnitude less than the chirp duration, namely, τ<<T_{c}.

$${r}_{b ( t )} = \frac{{A}_{T} {A}_{R}}{2} cos ( 2 π ( {f}_{min} τ + S τ t - \frac{1}{2} S {τ}^{2} ) ) \approx \frac{{A}_{T} {A}_{R}}{2} cos ( 2 π S τ T - 2 π {f}_{min} τ ) \qquad ( 18 )$$

Two of the parameters that the beat signal has will be described in further in this disclosure, namely the beat frequency f_{b} and the beat phase φ_{b}. The beat frequency is used to estimate the object range R₀. The beat frequency can be expressed according to Equation 19. The beat phase can be expressed according to Equation 20.

$${f}_{b} = S τ = \frac{S 2 {R}_{o}}{c} \qquad ( 19 )$$

$${ϕ}_{b} = 2 π {f}_{min} τ \qquad ( 20 )$$

Further, for a moving target object, the velocity can be estimated using beat phases corresponding to at least two consecutive chirps. For example, if two chirps 506 are transmitted with a time separation of Δt_{c} (where Δt_{c}>T_{c}), then the difference in beat phases is expressed according to Equation 21, where v₀ is the velocity of the object.

$$Δ {ϕ}_{b} = \frac{4 π Δ R}{{λ}_{max}} = \frac{4 π {v}_{o} Δ {t}_{c}}{{λ}_{max}} \qquad ( 21 )$$

The beat frequency is obtained by taking the Fourier transform of the beat signal that directly gives the range R₀. To do so, the beat signal r_{b}(t) is passed through an analog to digital converter (ADC) 508 with a sampling frequency Fₛ. The sample frequency can be expressed according to Equation 22, where Tₛ represents the sampling period. As a consequence, each chirp 506 is sampled Nₛ times where the chirp duration T_{c} is expressed according to Equation 23.

$${F}_{s} = \frac{1}{{T}_{s}} \qquad ( 22 )$$

$${T}_{c} = {N}_{s} {T}_{s} \qquad ( 23 )$$

The ADC output 510 corresponding to the n-th chirp is xₙ∈ [symbol] ^{N}^{ₛ}^{×1} and defined according to Equation 24. The Nₛ-point fast Fourier transform (FFT) output of xₙ is denoted as Xₙ. Assuming a single object, the frequency bin that corresponds to the beat frequency can be obtained according to Equation 25. In consideration of the fact that the radar resolution Imin is expressed as the speed of light c divided by double the chirp bandwidth B (shown above in Equation 13), the n-th bin of the FFT output corresponds to a target located within

$$[ \frac{kc}{2 B} - \frac{kc}{4 B} , \frac{kc}{2 B} + \frac{kc}{4 B} ] for 1 \leq k \leq {N}_{s} - 1.$$

As the range information of the object is embedded in Xₙ, it is also referred to as the range FFT.

$${x}_{n} = [ {\{ x [ k , n ] \}}_{k = 0}^{{N}_{s} - 1} ] where x [ k , n ] = {r}_{b} ( n Δ {t}_{c} + {kT}_{s} ) \qquad ( 24 )$$

$${k}^{*} = arg max {‖ {X}_{n} ‖}^{2} \qquad ( 25 )$$

FIG. 6 illustrates a frame-based radar transmission timing structure 600 in accordance with an embodiment of this disclosure. The embodiments of the frame-based radar transmission timing structure 600 illustrated in FIG. 6 are for illustration only, and other embodiments can be used without departing from the scope of the present disclosure.

The radar transmission timing structure 600 is used to facilitate velocity estimation. The radar transmissions are divided into frames 602, where each frame comprises N_{c} equally spaced chirps 606. The chirps 606 of FIG. 6 can be similar to the chirps 506 of FIG. 5. The range FFT of each chirp 606 provides the phase information on each range bin. For a given range bin, the Doppler spectrum, which includes the velocity information, is obtained by applying N_{c}-point FFT across the range FFTs of chirps corresponding to that range bin. The range-Doppler map (RDM) is constructed by repeating the above-described procedure for each range bin. The RDM is denoted as M, which is obtained by taking N_{c}-point FFT across all the columns of R. In Equation 26, this disclosure provides the following mathematical definition:

$$R ∈ {C}^{{N}_{c} \times {N}_{s}} as R = {[ {X}_{0} , {X}_{1} , … , {X}_{{N}_{c} - 1} ]}^{T} \qquad ( 26 )$$

The minimum velocity that can be estimated corresponds to the Doppler resolution, which is inversely proportional to the number of chirps N_{c} and is expressed according to Equation 27.

$${v}_{min} = \frac{{λ}_{max}}{2 {N}_{c} {T}_{c}} \qquad ( 27 )$$

Further, the maximum velocity that can be estimated as shown in Equation 28.

$${v}_{max} = \frac{{N}_{c}}{2} {v}_{min} = \frac{{λ}_{max}}{4 {T}_{c}} \qquad ( 28 )$$

As an example, the FMCW transceiver system 500 of FIG. 5 can generate and utilize the frame-based radar transmission timing structure 600 of FIG. 6 for further processing, such as radar signal processing that includes clutter removal. The description of a clutter removal procedure will refer to both FIGS. 5 and 6.

In the case of a monostatic radar, the RDM obtained using the above-described technique has significant power contributions from direct leakage from the transmitting antenna 502 to the receiving antennas 504. Further, the contributions (e.g., power contributions) from larger and slowly moving body parts, such as the first and forearm, can be higher compared to the power contributions from the fingers. Because the transmit and receive antennas 502 and 504 are static, the direct leakage appears in the zero-Doppler bin in the RDM. On the other hand, the larger body parts (such as the first and forearm) move relatively slowly compared to the fingers. Hence, signal contributions from the larger body parts mainly concentrate at lower velocities. Because the contributions from both these artifacts dominate the desired signal in the RDM, the clutter removal procedure according to embodiments of this disclosure remove them using appropriate signal processing techniques. The static contribution from the direct leakage is simply removed by nulling the zero-Doppler bin. To remove the contributions from slowly moving body parts, the sampled beat signal of all the chirps in a frame are passed through a first-order infinite impulse response (IIR) filter. For the reference frame f 602, the clutter removed samples corresponding to all the chirps can be obtained as expressed in Equation 29, where y̅_̅{̅f̅}̅[k, n] includes contributions from all previous samples of different chirps in the frame.

$$[ k , n ] = {x}_{f} [ k , n ] - \overline{{y}_{f}} [ k , n - 1 ] \qquad ( 29 )$$

$$\overline{{y}_{f}} [ k , n ] = {ax}_{f} [ k , n ] + ( 1 - a ) \overline{{y}_{f}} [ k , n - 1 ]$$

$$for 0 \leq k \leq {N}_{s} - 1 and 0 \leq n \leq {N}_{c} - 1$$

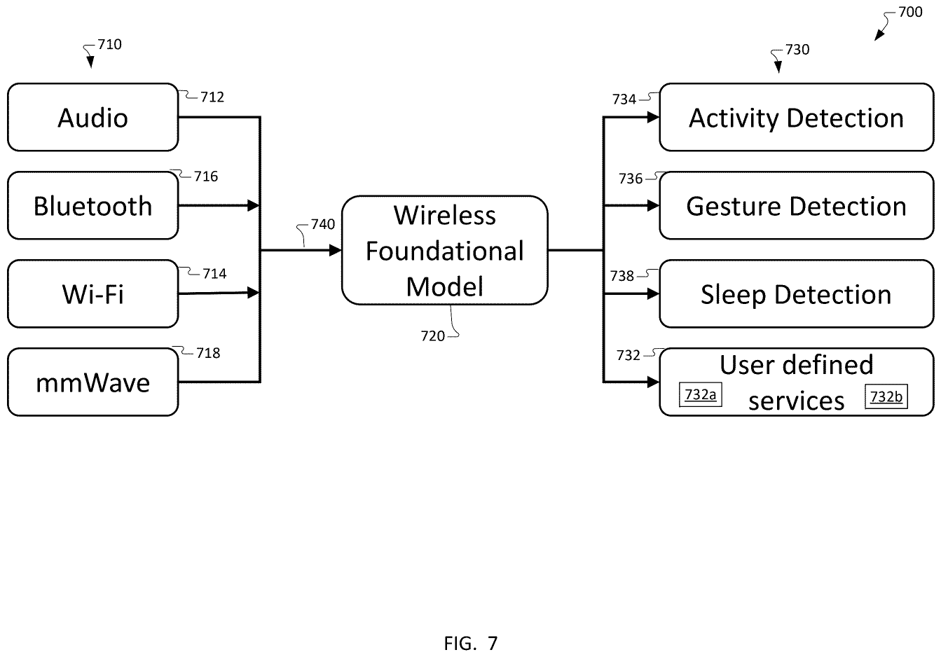

FIG. 7 illustrates a block diagram of an ambient wireless sensing system 700 in accordance with an embodiment of this disclosure. The embodiment of the system 700 shown in FIG. 7 is for illustration only, and other embodiments could be used without departing from the scope of this disclosure.

The ambient wireless sensing system 700 includes multiple sensors 710, such as audio sensors 712, Bluetooth™ sensors 716, Wi-Fi sensors 714, and mm Wave radars 718. The system 700 includes one or more foundational machine learning (ML) models 720 configured for (for example, trained to process inputs from) the sensor domain. The wireless foundational model(s) 720 that generates output uses to perform various tasks 730. Examples of the tasks 730 include user-defined services 732, human pose estimation (HPE) 732a, intruder detection 732b, activity detection 734, micro-gesture detection 736, sleep stage detection 738, and more. In some embodiments, HPE 732a task or intruder detection 732b are included among the user-defined services 732, and in other embodiments, those tasks 732a-732b can be separate from the user-defined services 732.

Within the system 700, the signals 740 from sensors 710 can be utilized through foundational machine learning (ML) models 720 to perform various tasks 730. The system 700 includes modalities that excel at presence detection and localization such as audio sensors 712, Wi-Fi transceiver 714, and Bluetooth transceiver 716, but these sensors 712, 714, 716 suffer from low resolution and are not suitable for tasks that require higher spatial accuracy such as HPE 732a. In contrast, mmWave radar 718 technology includes a significantly larger operation bandwidth that provides superior spatial resolution that enables accurate pose estimation and subsequent downstream tasks such as accurate human activity recognition (HAR).

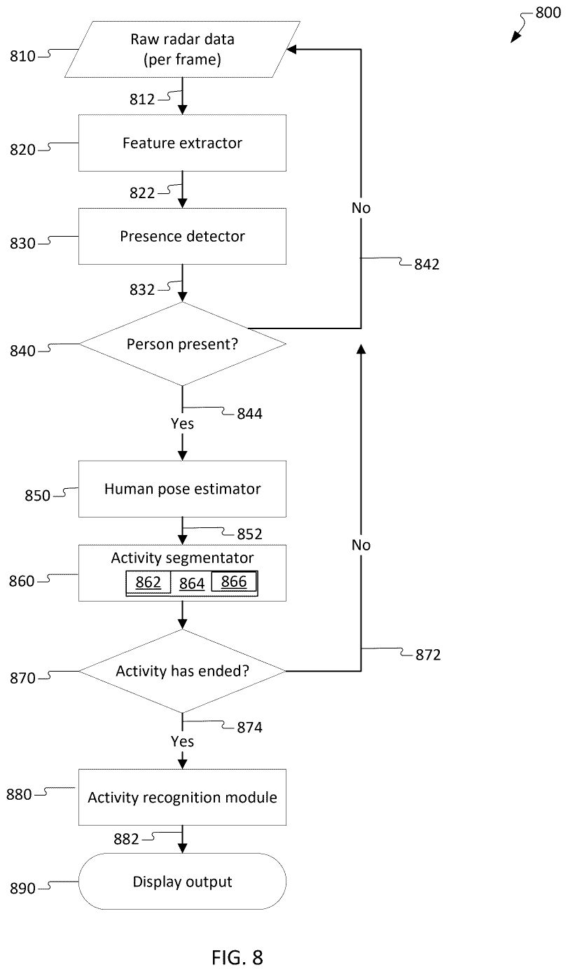

FIG. 8 illustrates a block diagram of a system 800 for human pose and activity estimation using mmWave radar in accordance with an embodiment of this disclosure. The embodiment of the system 800 shown in FIG. 8 is for illustration only, and other embodiments could be used without departing from the scope of this disclosure.

The system 800 is an end-to-end pipeline that includes HPE and HAR, separately. The end-to-end pipeline system 800 retrieves raw radar data 810 to be processed. Within the end-to-end pipeline system 800, a radar frame is fetched periodically with a frame duration t_{f} (also denoted as T_{f}). For example, the system 800 can include a radar controller controlling power to the radar transceiver, controlling timing to transmit and receive radar signals, and thereby retrieving a stream of raw radar data. For example, the stream of raw radar data 810 retrieved from the mmWave radar transceiver includes multiple consecutive radar frames 602, such as a current frame f 602 in FIG. 6 retrieved at a current time, which is subsequent to a previous frame f−1 retrieved prior to the current time.

The end-to-end pipeline system 800 includes some components that process one radar frame at a time or process each radar frame sequentially, for example, a feature extraction module (feature extractor) 820, a presence detection module (presence detector) 830, a first trigger 840, and a human pose estimator 850. Other components within the end-to-end pipeline system 800 process multiple frames as a set, for example, the activity segmentation module (activity segmenter) 860, second trigger 870, and activity recognition module 880.

Within the end-to-end pipeline system 800, the feature extraction module 820 receives the raw radar data 810 and generates appropriate features depending on the implementation. In other words, the feature extractor 820 receives a radar frame 812 as input, and extracts a set of features 822 from the received radar frame 812. The set of features 822 are used as the input feature to the ML model for pose estimation. For example, the features can be Range-Doppler map (RDM), Range-Azimuth angle map (RAM), or Range-Elevation angle map (REM). In some embodiments, the features extractor 820 generates point clouds from the RDM, RAM, REM as the set of features 822 to be input to the ML model for pose estimation.

In some embodiments, the feature extraction module 820 retrieves the raw radar data 810 as input and generates the RDM by performing fast Fourier transform (FFT) in the samples per each chirp 606 and across each range bin. The feature extraction module 820 generates the range angle maps (such as RAM and REM) by performing a Fourier transform across each sample (for example across each chirp 606, or across each frame 602). Alternatively for each range bin, the angle spectrum (such as RAM and REM) may be obtained by using an appropriate signal processing algorithm such as multiple signal classification (MUSIC) or minimum variance distortionless response (MVDR) on each range bin. The advantages of using MUSIC or MVDR over FFT is higher angular resolution that may be useful when the radar has fewer antennas.

Next, using the extracted set of features 822, the presence detector 830 can detect the presence of the person in the field of view of the radar. In other words, the presence detection module 830 applies a presence detection algorithm to features extracted from the current radar frame and thereby generates an indicator 832 of whether a human is or is not present for the current frame.

At the block corresponding to a first trigger 840, the system 800 determines whether to input the set of features 822 into the HPE 850. If a person is absent, then no further steps are taken. In other words, in response to a determination 842 that a human is not present in the radar field of view for the current frame, the system 800 does not input the set of features 822 for the current frame into the HPE 850. In some embodiments, the determination 842 causes the system 800 to discard the set of features 822 for the current frame and the raw radar data 812 of the current frame.

In contrast, if presence detection of a human is successful, then the features are passed through a pre-trained neural network to estimate the human pose. In other words, in response to a determination 844 that a human is present in the radar field of view for the current frame, the system 800 inputs the set of features 822 for the current frame into the HPE 850.

The HPE 850 includes a machine-learning (ML) model that is configured to estimate a pose of the human based on learned spatial relationships among a set of different human body parts and a learned temporal variations of the different human body parts across multiple time instances. The human pose 852 generated by the HPE 850 includes a set of spatial relationships among the set of different human body parts at the current frame. For example, if the human body detected within the radar field of view is in a sitting pose, then the HPE 850 can determine a human pose 852 that includes a hip-to-ankle distance and knee-to-ankle distance that are close to each other. As another example, if the human body detected within the radar field of view is in a standing pose, then the HPE 850 can determine a human pose 852 that includes a includes a hip-to-ankle distance much greater than the knee-to-ankle distance.

If the activity segmenter 860 determines the current frame satisfies an activity-start condition, then the current frame is a candidate-start frame that potentially includes a start of an activity. The candidate-start frame gets input into a queue 862. For example, the activity segmenter 860 includes a buffer that includes a first in first out (FIFO) queue 862 that can hold Nᵥ radar frames. The activity segmenter 860 also includes data window 864 that accumulates consecutive radar frames, starting with a start-candidate frame followed by subsequent radar frames.

Once a sufficient number of frames are accumulated, the sequence of human poses is passed through the activity segmentation module 860, which marks the potential start and end frames of the activity. For example, the activity segmentation module 860 selects, from among the frames in the queue 862, frames to be added to a data window 864; and segments the data window 864 into non-activity frames and a set of activity frames 866 corresponding to a single action. The set of segmented frames containing the activities may be fed into an ML-trained action recognition module 880 to identify the activities as an action. Although movement of the human body can be due to the human performing one or more activities, this disclosure focuses on radar data and inferences that can be drawn therefrom. For ease of differentiation, this disclosure uses the term “action” to refer to a sequence of human poses from a start through an end, and uses the term “activity” to refer radar data 812, 844, 852 that satisfies criteria corresponding to movement of the human body during performance of one or multiple human poses.

At the block corresponding to a second trigger 870, the system 800 determines whether to input the set of activity frames 866 into the activity recognition module 880. The activity segmenter 860 analyzes the velocity of different human joints to determine if activity has ended. If the activity segmenter 860 makes a determination 872 that activity has not yet ended, then the system 800 processes the next frame of raw radar data 810. If the activity segmenter 860 makes a determination 874 that activity has ended, then the activity recognition module 880 receives the set of activity frames 866 as input.

The activity recognition module 880 identifies the action by obtaining a label 882 for the action. In some embodiments, the activity recognition module 880 prompts a vision language model (VLM) by inputting the estimation of the human poses as the input prompt to the VLM to make zero-shot inference. The process repeats for each potential activity performed by the user. These identified actions can be utilized by other modules for further analysis such as exercise coaching, sleep monitoring, etc.

At block 890, the output from the system 800 displays via the display 160 of FIG. 1 or display 255 of FIG. 2. The output from the system 800 can include the label 882, a plot of the human pose 852, plots of a sequence of poses corresponding to the set of activity frames 866. The plots of a sequence of poses can be displayed sequentially as an animation video, or can be displayed as an array of images.

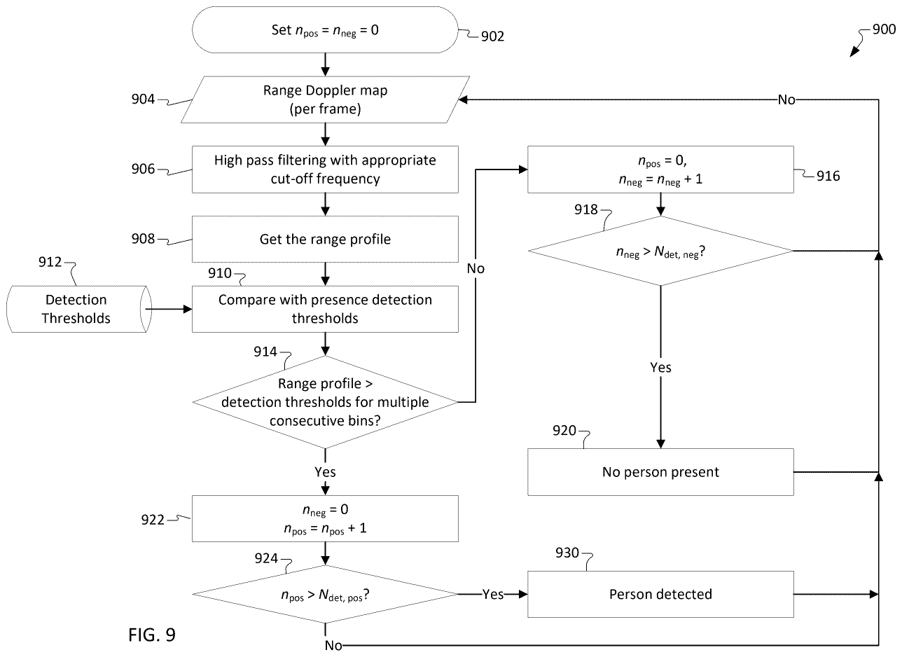

FIG. 9 illustrates a method 900 for human presence detection in accordance with an embodiment of this disclosure. The embodiment of the method 900 shown in FIG. 9 is for illustration only, and other embodiments could be used without departing from the scope of this disclosure. The method 900 is performed by the presence detector 830 of FIG. 8, such as a processor of the electronic device 101 executing the application 147 of FIG. 1 that includes the presence detection module 830 of FIG. 8.

The method 900 initializes at block 902, in which the presence detector 830 sets the nₚₒₛ parameter and n_{neg} parameter both equal to a zero value. The frame counter neg is a parameter that denotes a number of frames where a person is absent from the field of view of the radar, and a frame counter nₚₒₛ is a parameter that denotes the number of frames where a person is present within the field of view of the radar. These parameters are described further herein.

At block 904, presence detector 830 obtains a Range-Doppler map (RDM) per frame. For example, presence detector 830 can receive the RDM feature among the set of features 822 extracted by the feature extractor 820 of FIG. 8.

The objective of the Presence Detector Module is to determine if a person is present or not within the field of view of the radar per radar frame. Block 920 represents a determination 842 that no person is present within the field of view of the radar, and block 930 represents a determination 844 that a person is detected as present within the field of view of the radar. If the person is not present, then subsequent complex signal processing steps (for example, signal processing procedures of the HPE 850) may be avoided resulting in efficient system operation. That is, the method 900 ends at block 920, and then restarts at block 904 to process a next radar frame.

At block 906, the presence detector 830 filters the RDM by applying a high-pass filter with an appropriate cut-off frequency. In each frame, the presence detector 830 can filter out the static objects from the RDM to obtain the range profile.

At block 908, the presence detector 830 obtains the range profile, which provides the received power per range bin. Next at block 910, the presence detector 830 compares the received power on each range bin to a set of predetermined presence detection thresholds 912.

The set of presence detection thresholds 912 can be obtained when the room is empty where the radar transceiver operates. These presence detection thresholds 912 can be periodically updated to capture any changes in the environment where the radar transceiver operates.

At block 914, if the range profile is greater than the set of predetermined presence detection thresholds 912 for a number of consecutive bins, then the method proceeds to block 922 at which an inference can be that a person might be present. The number of consecutive bins can be at least 50 cm or more for marking the frame as a positive frame where the person is detected to be present. Else in the case that the range profile is not greater than the set of predetermined presence detection thresholds 912 for the number of consecutive bins, then the method proceed to block 916 at which an inference can be that a person might be absent.

Once the presence of the person is detected, the presence detector 830 increments the frame counter nₚₒₛ that corresponds to the number of frames where the human presence is present, at block 922. At block 924, the frame counter nₚₒₛ is compared to a count threshold N_{det}, pos for converting the inference can be that a person might be present into a determination (for example, a confirmation) that the person is present. Once the frame counter nₚₒₛ is greater than the count threshold N_{det,pos}, such as if the person is detected to be present for N_{det,pos} frames, the presence detector 830 can declare that the person is present. In some embodiments, this declaration at block 830 can activate the HPE 850, to enable the activated HPE to receive input features such as the set of extracted features 822.

The procedure at block 916 and 918 are analogous to the procedures of blocks 922 and 924, respectively. This procedure at blocks 918 and 924 of counting or combining inferences over multiple frames over multiple frames ensures that the false positives or false negatives are reduced (for example, minimized). At block 916, the presence detector 830 increments the frame counter n_{neg} that corresponds to human absence. At block 918, if the number of consecutive frames n_{neg}, where the person is absent, is more than a predefined number of frames N_{det,neg}, then method proceeds to block 920 at which the presence detector 830 declares that no person is present.

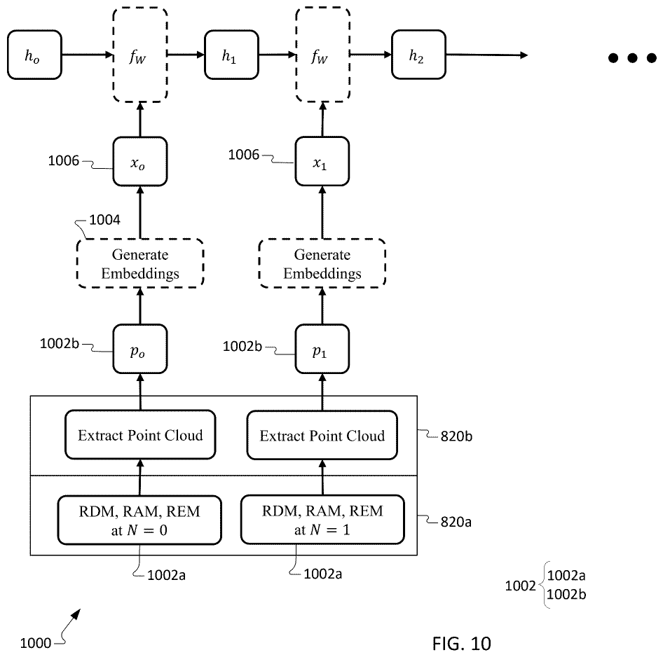

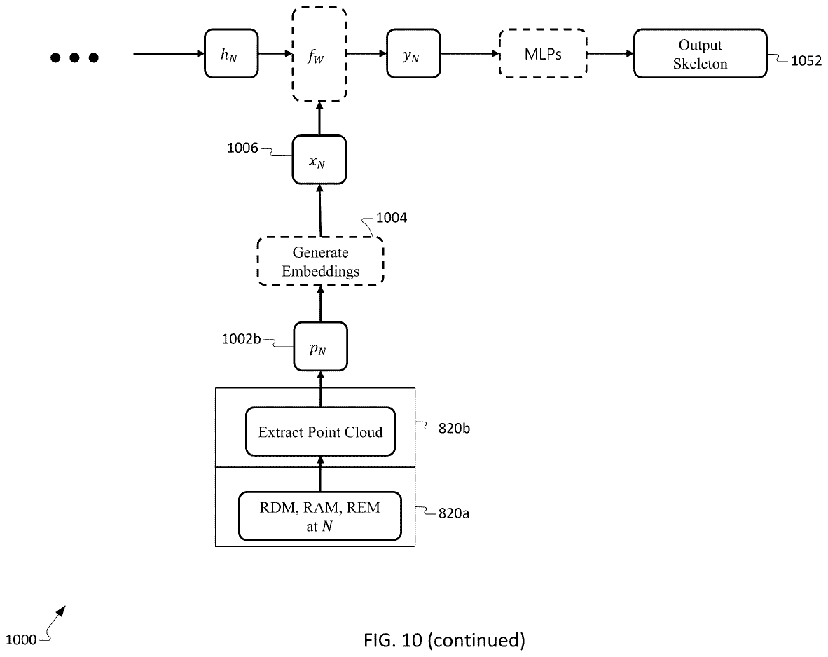

Depending on the feature type, FIGS. 10, 11, and 12 of this disclosure provide several different ML model architectures to learn the spatial and temporal dependencies among joint locations. The goal of learning the spatial pattern is to understand learn the spatial relationships among the human joints. In FIG. 10, this disclosure provides one such ML model architecture. FIG. 10 illustrates a human pose estimator 1000 that includes a recurrent neural network based (RNN-based) model architecture in accordance with an embodiment of this disclosure. The embodiment of the HPE 1000 shown in FIG. 10 is for illustration only, and other embodiments could be used without departing from the scope of this disclosure. The HPE 1000, input features 1002, and output skeleton 1052 of FIG. 10 can be the HPE 850, the set of features 822, and the human pose 852 of FIG. 8, respectively.

The goal of the HPE 1000 is to estimate the key joint locations of a human body from the input features 1002 using a machine learning model. The RNN-based architecture of the HPE 1000 takes a sequence of N point clouds as input features to estimate a skeleton 1052 (user pose) for the N-th frame. The N-th frame is the current radar frame, where the frame index n=N, and where the previous frames n=0 correspond to n=1 and so forth.

The input features 1002 to the ML model can be either (1) RDM, RAM, and REM 1002a or (2) point cloud 1002b obtained from RDM, RAM, and REM. In one embodiments, the HPE 1000 is configured to receive the RDM, RAM, and REM 1002a per frame as input features 1002 from a first feature extractor 820a, and the RNN-based model architecture includes a second feature extractor 820b that extracts a pointcloud 1002b per frame {p₀, p₁, . . . p_{N},} from the input features 1002a. In another embodiment, the HPE 1000 is configured to receive the pointcloud 1002b per frame as input features 1002 from a feature extractor that includes both the first and second feature extractors 820a-820b. The second feature extractor 820b generates point clouds 1002b from RDM, RAM, and REM 1002a using appropriate signal processing methods.

Depending on the application type, one set of features may be preferred over the other. For example, if the inference is to be generated in a remote/cloud server (such as the server 106 executing the presence detection method 900 of FIG. 9), then pointcloud 1002b might be preferred as the input features 1002 because data transmission overhead is much less compared to transmitting raw RDM, RAM, and REM 1002a. In contrast, if the inference is done locally (such as the electronic device 101 executing the presence detection method 900 of FIG. 9), then raw range map features 1002a may be preferred as input features 1002 because higher accuracy can be provided by signal processing locally, especially in cluttered environment. A cluttered environment usually causes signal interference and degradation of signal quality.

Once the pointcloud 1002b is generated, it is passed through an embedding model 1004 to generate input embedding vectors 1006 for the recurrent neural network. The RNN can be implemented through either long short-term memory (LSTM) or gated recurrent unit (GRU). The embedding model 1004 can use a deep learning model for pointcloud processing, such as PointNet, PointNet⁺⁺, PointMLP, or dynamic graph convolutional neural network (DGCNN).

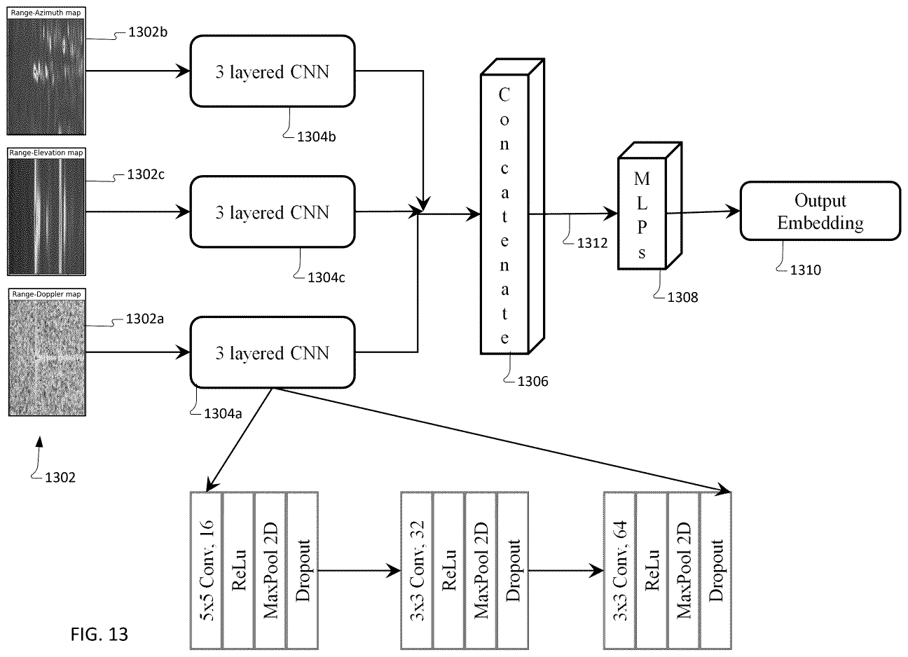

Within the RNN-based model architecture of the HPE 1000, the dotted boxes represent learnable parameters. The RNN GRU-based model learns the temporal feature across frames. For each frame, the HPE 1000 uses a convolutional neural network (CNN) to learn spatial dependencies among different body parts. The CNN-layers can be through an embedding layer, such as the CNN architecture 1300 of FIG. 13 described further herein.

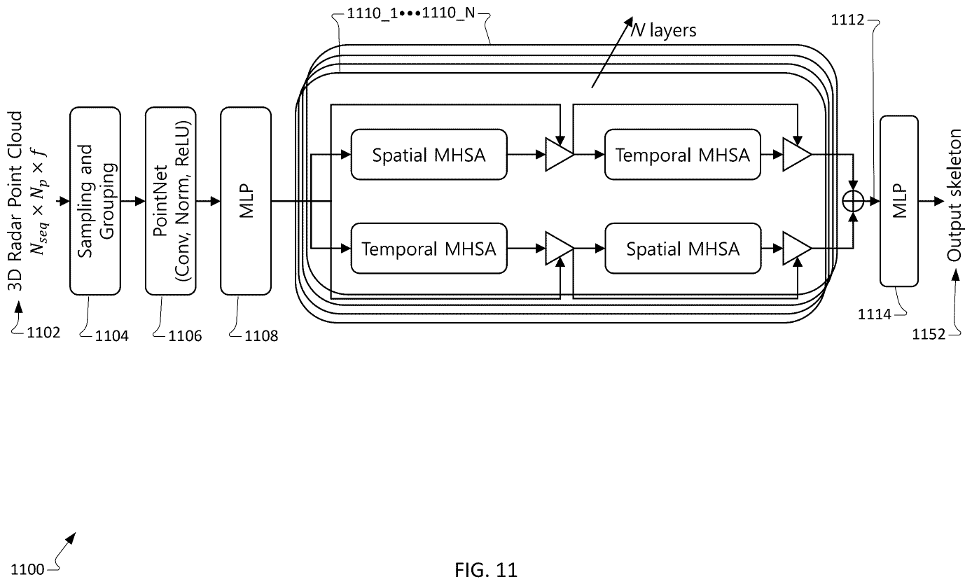

FIG. 11 illustrates a human pose estimator 1100 that includes transformer-based model architecture in accordance with an embodiment of this disclosure. The embodiment of the HPE 1100 shown in FIG. 11 is for illustration only, and other embodiments could be used without departing from the scope of this disclosure.

The transformer-based model architecture is configured to receive and use three dimensional radar pointclouds 1102 as input features, which can be the same as or similar to the pointclouds 1002b of FIG. 10. The pointclouds 1102 can be denoted as N_{seq}×Nₚ×f. The input pointcloud features 1102 could include 3D-cartesian coordinates (x, y, z) as well as corresponding velocity (v), energy (e), signal-to-noise ratio(s), and radial distance (r). The input pointcloud features 1102 may also include a subset of these 7 features to reduce the complexity. As a comparison, the RNN of the ML architecture of FIG. 10 is replaced by transformers as an alternative architecture used to learn the spatial dependencies among joints and temporal dependencies across multiple frames for a given feature corresponding to a joint.

At block 1104, the pointclouds 1102 undergo a sampling and grouping procedure. The HPE 1100 uses the encoder 1106 of PointNet⁺⁺ to embed the radar pointcloud 1102 to a higher dimensional feature. The HPE 1000 includes a first multilayer perceptron (MLP). A sequence of feature vector is then passed through several spatial and temporal multi-head self-attention (MHSA) blocks 1110_1-1110_N to learn the dependencies among joints across frames. The final output 1112 is passed through a second MLP 1114 to generate the output pose (skeleton) 1152 of the subject (i.e., human user) corresponding to the current frame.

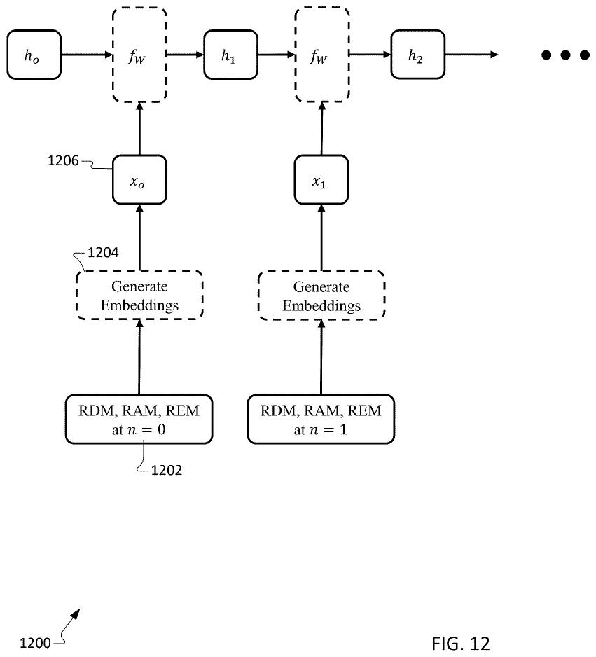

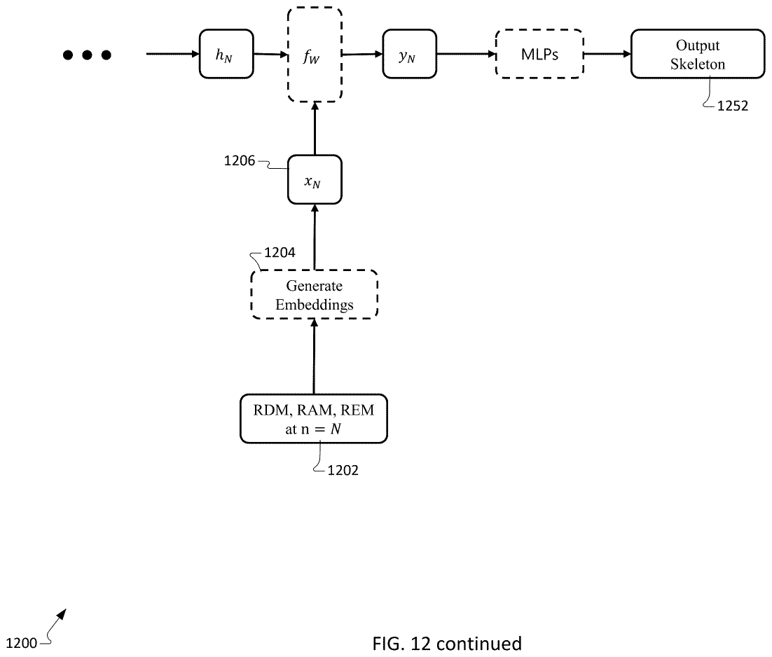

FIG. 12 illustrates a human pose estimator 1200 that includes an RNN-based model architecture without a pointcloud extractor in accordance with an embodiment of this disclosure. The embodiment of the HPE 1200 shown in FIG. 12 is for illustration only, and other embodiments could be used without departing from the scope of this disclosure. The HPE 1200, input features 1202, and output skeleton 1252 of FIG. 12 can be the HPE 850, the set of features 822, and the human pose 852 of FIG. 8, respectively. The embedding model 1204 can perform a similar function as the embedding model 1004 of FIG. 10. The input features 1202 and embedding vectors 1206 of FIG. 12 can be the same as or similar to corresponding input and output 1002a and 1006 of FIG. 10, respectively.

The RNN-based model architecture of the HPE 1200 is configured to receive the input features 1102 that are RDM, RAM, and REM per frame. To capture the spatial dependencies among the keypoints for a given frame, the embedding vectors 1206 are generated using a multilayer CNN architecture, such as the CNN architecture 1300 of FIG. 13. The HPE 1200 is similar to the HPE 1000 of FIG. 10, and uses an RNN implemented through GRU to capture the temporal relationship of the signal generated by the motion of the different body parts.

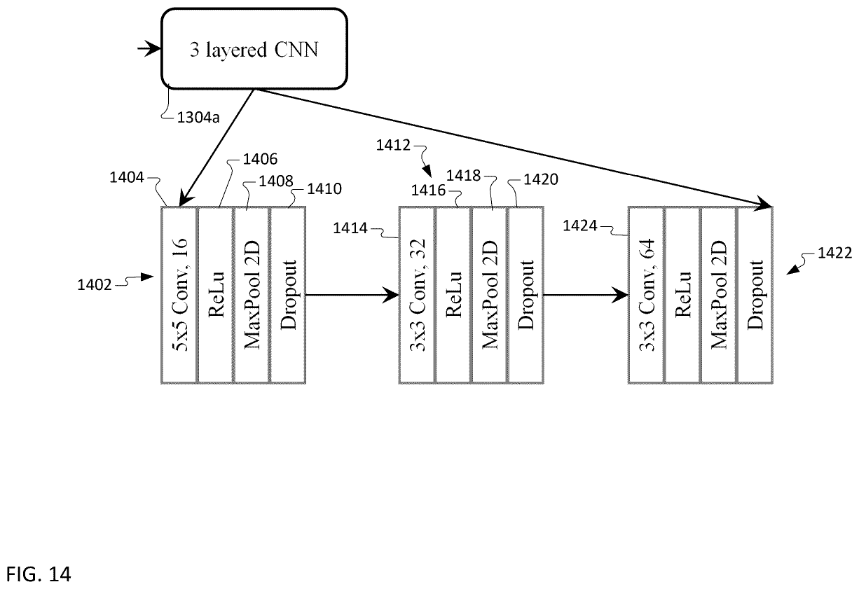

FIG. 13 and FIG. 14 are described together. FIG. 13 illustrates a three-layered CNN architecture 1300 used for generating embeddings from RDM, RAM, and REM in a human pose estimator in accordance with an embodiment of this disclosure. FIG. 14 illustrates the convolutional neural network (CNN) of FIG. 13 in accordance with an embodiment of this disclosure. The embodiment of the CNN architecture 1300 shown in FIGS. 13-14 is for illustration only, and other embodiments could be used without departing from the scope of this disclosure.

The CNN architecture 1300 can be used in the embedding model 1004 of FIG. 10 or the embedding model 1204 of FIG. 12. The input features 1302 can be the input features 1002a of FIG. 10, or the input features 1202 of FIG. 12. The output embeddings 1310 can be the embedding vectors 1006 of FIG. 10, or the embedding vectors 1206 of FIG. 12.

The CNN architecture 1300 is configured to receive an RDM 1302a, RAM 1302b, and REM 1302c as input features 1302. The CNN architecture 1300 can first process each of the range-feature maps 1302a-1203c separately through the three-layered CNNs 1304a-12304c, respectively. The CNN architecture 1300 includes a concatenator 1306 and multiple layers MLPs 1308. The goal of the three-layered CNN architecture 1300 is generating the embeddings 1310 from the three range-feature maps. The output embeddings 1310 are generated by passing a concatenated output 1312 of each feature through multiple layers of MLPs 1308.

### Training the Model

For training the ML model of the human pose estimator to output the human skeleton (i.e., pose of a human) from input features, the training procedure of this disclosure poses a problem as a regression problem. In this case, the HPE model tries to minimize the 3D mean squared error (MSE) between the ground truth and predicted joint locations. The loss function may be expressed as shown in Equation 30, where y_{pred}∈R^{N}^{ₖₚ}^{×3} denotes the (x, y, z) locations of the predicted Nₖₚ joints and y_{gt} denotes the corresponding ground-truth. Both the y_{pred} and the y_{gt} are vectors.

$${ℒ}_{3 D , mse} = \frac{‖ {y}_{pred} - {y}_{gt} {‖}_{2}}{{N}_{kp}} \qquad ( 30 )$$

The training procedure of this disclosure can analyze more complex loss functions that, in combination with the joint location MSE, can also analyze the error in speed of each joint, and the bone length. The loss function may be expressed as shown in Equation 31, where v_{pred} and v_{gt} are the predicted and ground-truth velocities of each keypoint, b_{pred} and b_{gt} are the predicted and ground-truth bone lengths of N_{b} bones, and α,β are weighting parameters for different types of loss. Both the v_{pred}, b_{pred}, and b_{gt} are vectors. The learnable parameters of each model architecture are trained using backpropagation to minimize the loss function.

$$ℒ = {ℒ}_{3 D , mse} + α \frac{‖ {v}_{pred} - {v}_{g t} {‖}_{2}}{{N}_{k p}} + β \frac{‖ {b}_{p r e d} - {b}_{g t} {‖}_{2}}{{N}_{b}} \qquad ( 31 )$$

Referring to FIG. 14, the three layered CNN 1304a of FIG. 13 is shown, but it is understood that the other CNNs 1304b-1304c could be the same or similar. The first layer 1402 includes a 5×5 convolution with 16 kernels 1404, an ReLu 1406, a MaxPool two dimensional 1408, and a dropout 1410. The second layer 1412 includes a 3×3 convolution with 32 kernels 1414, an ReLu 1416, a MaxPool two dimensional 1418, and a dropout 1420. The third layer 1422 is similar to the second layer 1412, except the 3×3 convolution has 64 kernels 1424.

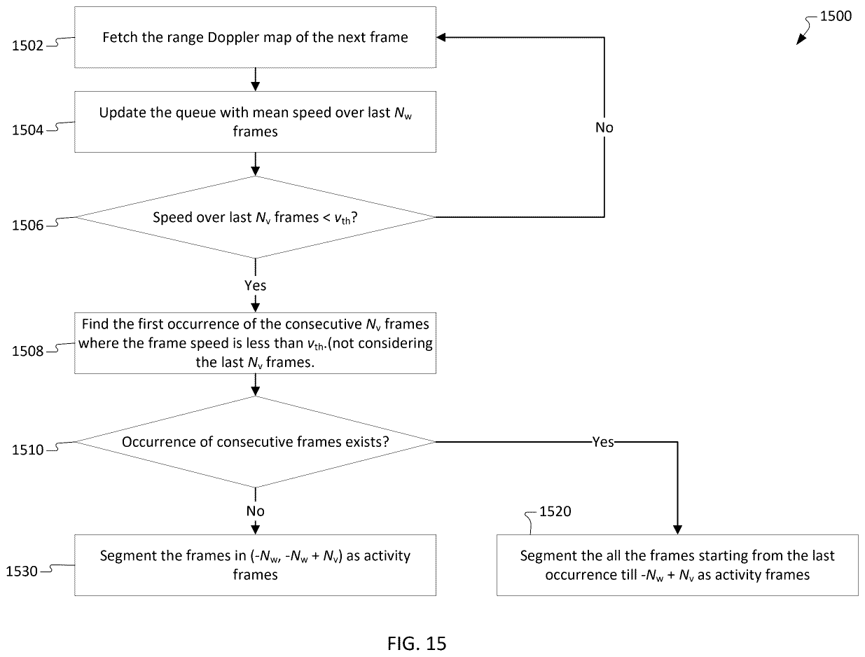

FIG. 15 illustrates a method 1500 for activity segmentation in accordance with an embodiment of this disclosure. The embodiment of the method 1500 shown in FIG. 15 is for illustration only, and other embodiments could be used without departing from the scope of this disclosure. The method 1500 is performed by the activity segmenter 860 of FIG. 8, such as a processor of the electronic device 101 executing the application 147 of FIG. 1 that includes the activity segmentation module 860 of FIG. 8.

In this embodiment, activity segmenter 860 implements velocity-based activity frame segmentation. A FIFO queue of length N_{w} (for example, data window 864) is maintained that store the average speed (v) of the person over last N_{w} frames. Further, Nᵥ<N_{w}, where Nᵥ frames may correspond to 500 ms while N_{w} may correspond to 5 seconds.

### Activity Segmentation Module (ASM)

In order for the activity recognizer 880 to perform activity recognition, the activity segmenter 860 accumulates and analyzes multiple sequential frames together to generate an appropriate inference. The quality of activity recognition depends on the selected frames for generating the inference. If the selected frames contain a single action, then inference quality (for example, reliability or accuracy compared to ground truth) improves. In contrast, if the selected frames contain more than one action due to improper segmentation, then quality of inference would degrade. The objective of the activity segmenter 860 is to segment a sequence of frames from a data window 864 of N_{w} frames and pass the selected set of activity frames 866 to the action recognition module 880 for inference. This disclosure provides multiple strategies for segmentation of activity frames from non-activity frames.

The method 1500 provides an average speed-based frame segmentation algorithm. The method 1500 can begin when the activity segmenter 860 receives the pose 852 of the current frame. At block 1502, the activity segmenter 860 retrieves the RDM of the next frame.

At block 1504, the activity segmenter 860 updates the queue with an average speed (\tilde{v}) over the last N_{w} frames. More particularly, the activity segmenter 860 extracts a body part speed of at least some among a set of different human body parts, from each radar frame within the queue. Further, the activity segmenter 860 calculates an average speed of the person (v) per frame, which can be the average of the body part speeds in the radar frame. The average speed can be a statistical mean. A buffer including a FIFO queue (such as data window 864) is maintained that stores the average speed (v) over multiple joint locations (for example, all joint locations or selected key joint locations) in last N_{w} frames. The value of N_{w} depends on the activity vocabulary. In a home environment the typical value may be set such that N_{w} frames cover 5 seconds.

At block 1506, the activity segmenter 860 determines whether a certain threshold velocity vₜₕ exceeds the average speed over the last N_{w} frames. When the average speed of the person (\tilde{v}) is less than the certain threshold velocity vₜₕ, then such comparison result may indicate that the activity performed by the person has ended because the person may be in a resting position, in which case the method 1500 returns to block 1502. The typical value of threshold velocity vₜₕ depends on the set of activities in the vocabulary. For example, in the case of high intensity cardio exercise, the velocity threshold may be set to 5 cm/s.

At blocks 1508-1530, the activity segmenter 860 performs functions to identify the start frame in this data window 864 of N_{w} frames. To determine the start frame, first at block 1508, the activity segmenter 860 searches from −N_{w} frame (for example, earliest past frame in the data window 864) onwards (for example, through past frames received at a later time than the −N_{w} frame) to try to find consecutive Nᵥ frames where the speed is less than vₜₕ (excluding the last Nᵥ frames). For example, the last Nᵥ frames can be the queue 862 of Nᵥ that includes the current frame (index n=1) and Nᵥ−1 past frames. For ease of explanation, the number of frames is a positive number, such as Nᵥ or N_{w}, but the frame indices (n) of past frames are negative numbers, such as the frame indices of the −N_{w} frame.

At block 1510, the activity segmenter 860 determines whether the search results include an occurrence of Nᵥ such consecutive frames respectively having a frame speed (for example, the average body speed of the multiple joints) less than the velocity threshold vₜₕ. If the occurrence exists, then at block 1520, the activity segmenter 860 marks the last frame of the occurrence as the start frame of the activity. In contrast, if no such occurrence of consecutive inactive frames is found, then at block 1530, the activity segmenter 860 marks (−N_{w},−N_{w}+Nᵥ) as the set of activity frames 866. From among data window 864 of the last N_{w} frames, the non-activity frames are those that are outside the set of activity frames.

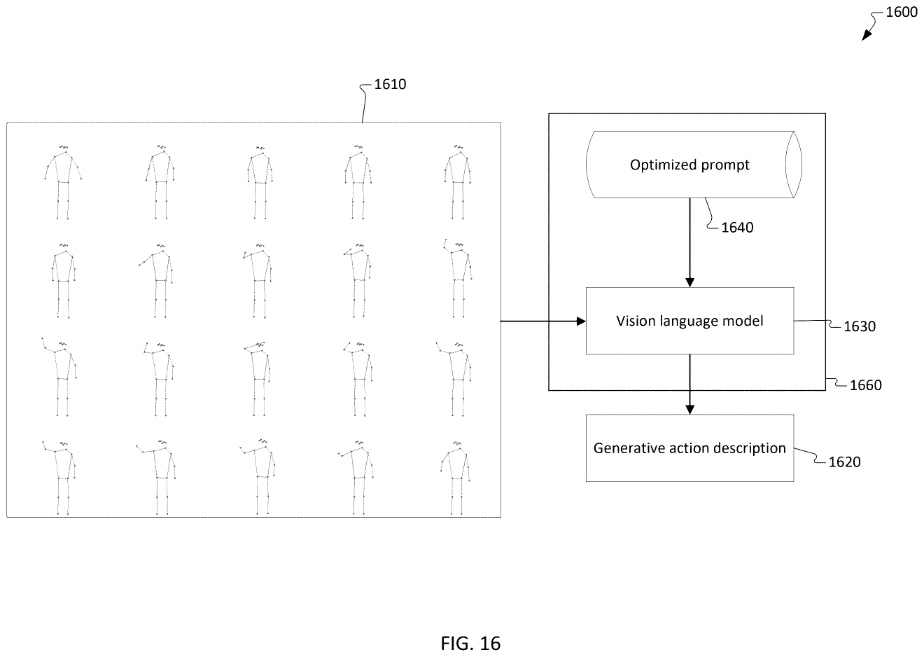

FIG. 16 illustrates an operation 1600 of a vision language model based (VLM-based) zero-shot activity segmenter 1660 in accordance with an embodiment of this disclosure. The embodiment of the zero-shot activity segmenter 1660 shown in FIG. 16 is for illustration only, and other embodiments could be used without departing from the scope of this disclosure.

The sequence of poses 1610 can be each human pose 852 that the HPE 850 generated for the set of activity frames 866, respectively. The zero-shot activity segmenter 1660 of FIG. 16 can be the activity segmenter 860 of FIG. 8. The zero-shot activity segmenter 1660 can include a vision language model 1630 and an optimized prompt 1640. The optimized prompt 1640 can be a repository that includes multiple selectable prompts. To optimize the prompt that the VLM receives, P-tuning occurs in the embedding domain.

In this example operation 1600, the sequence of poses 1610 corresponds to a sequence of twenty (20) segmented activity frames that are input to the VLM 1630 along with optimized prompts 1640 to obtain a zero-shot response 1620. The zero-shot response 1620 can be a generative action description, which can be in textual format. The zero-shot response 1620 can be a label of a single action that corresponds to the sequence of poses 1610.

In this operation 1600, the zero-shot activity recognition capabilities of the VLM 1630 are used to design a more robust activity recognition module by clustering the similar activities together. This automated activity labeling operation 1600 requires minimal effort compared to manual data labeling, which leads to scalability for building a vocabulary that contains a large number of actions.

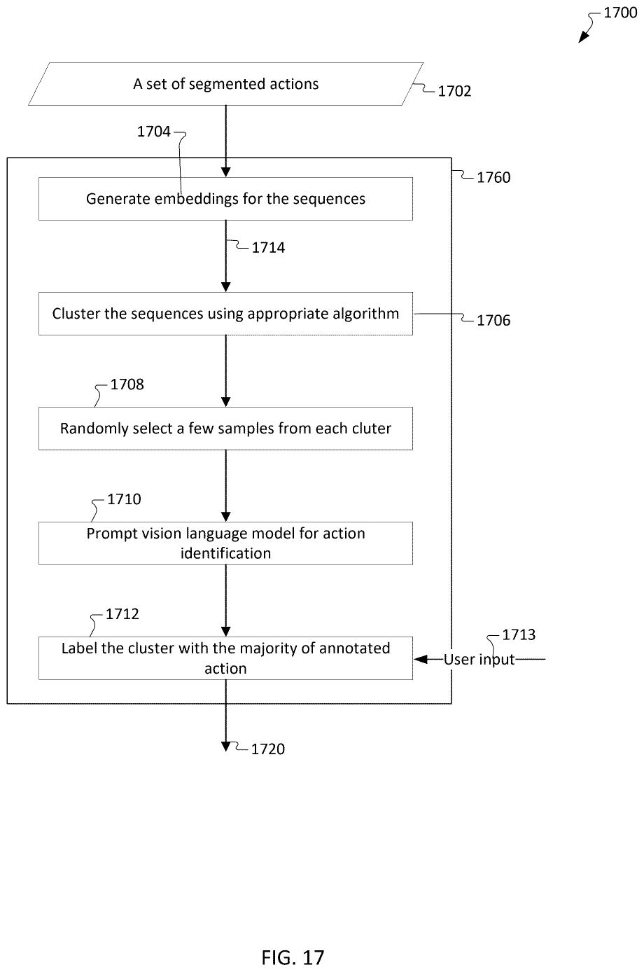

FIG. 17 illustrates a process 1700 for local nominal-shot activity recognition in accordance with an embodiment of this disclosure. The embodiment of the process 1700 shown in FIG. 17 is for illustration only, and other embodiments could be used without departing from the scope of this disclosure.

The local activity recognizer 1760 performs the process 1700 of automated activities labeling of using a state of an art vision language model 1730. The VLM 1730 in FIG. 17 can perform a same function as the VLM 1630 of FIG. 16. The local activity recognizer 1760 can be stored locally within the memory 130 of the electronic device 101 of FIG. 1, or within the memory 260 of the user's electronic device 200 of FIG. 2.

This automated activity labeling process 1700 includes two main steps. In the first step, the local activity recognizer 1760 clusters similar activities (labeled by the VLM or a human expert) in a higher dimensional embedding space. In the second step, for a given activity the local activity recognizer 1760 can perform inference by comparing the clusters to the centroid of each cluster of activities and outputting the result as the action related to the nearest cluster below a certain threshold thₚᵣₒₓ (for example, a threshold of proximity of data points to the centroid). If the nearest cluster is greater than a certain threshold thₚᵣₒₓ, then this action may be a new class (for example, an unseen action). Therefore, the local activity recognizer 1760 may prompt the user to input the action type as a label which can be considered as the centroid of a new cluster. The centroid is updated as local activity recognizer 1760 encounters and processes more iterations of this particular action (corresponding to the new cluster) in future.

The process 1700 can begin when a set of segmented actions 1702 are received, which can be a training dataset in which each segmented action includes a sequence of poses (such as the sequence of poses 1610) corresponding to a set of activity frames.

The local activity recognizer 1760 can be a processing pipeline of generating labels for similar activities under weak supervision. The procedures of blocks 1704-1712 within the processing pipeline are used to process each respective sequence of poses (i.e., each respective segmented action from among the set 1702).

At block 1704, the embeddings of the different segmented action frames among the set 1702 are used to generate a single embedding 1714 for the entire sequence. One approach to obtain a single embedding 1714 is to perform average pooling across all the frames in the sequence. Embedding are vectors corresponding to different actions, or different sets of activity frames.

At block 1706, the local activity recognizer 1760 clusters the sequences using an appropriate clustering algorithm, thereby generating a set of clusters. Examples of the appropriate clustering algorithm include a Gaussian mixture model (GMM), K-means clustering, etc. In some embodiments, the procedure of block 1706 is performed once a sufficient number of samples are annotated. Different actions correspond to different clusters, which can be annotated respectively.

Post clustering at block 1708, a few samples from each cluster are selected for labeling. For example, the local activity recognizer 1760 can randomly select the few samples from among each cluster. Each sample is one of the sequences of poses.

For simplicity, blocks 1710-1712 are described as processing a single segmented action (for example, processing the selected samples per cluster). However, it is understood that an electronic device can include multiple VLMs 1760 or multiple blocks 1712 such that multiple segmented actions can be respectively input to multiple processing pipelines, respectively. That way, the automated activity labeling process 1700 can concurrently label multiple segmented actions.

At block 1710, the activity segmenter 1760 prompts a VLM for action identification of the selected samples, which automatically labels each respectively cluster with an annotated action output from the VLM. The labeling of each cluster can be performed apriori by the vision language model at block 1710, such as before the training of the activity segmenter 760 is completed. The response resulting from prompting the VLM at block 1710 or resulting from prompting the user at block 1712 is referred to herein as an “action annotation” for the sequence of poses corresponding to the segmented set of activity frames of the single action. That is, the generative action description is the action annotation, which can be the label of the cluster. In some embodiments, the label output 1720 from the local activity recognizer 1760 can be the generative action description output from the VLM at block 1710.

At block 1712, the local activity recognizer 1760 selects a cluster (from among the set of clusters generated at block 1706) that has a majority of annotated actions. In some embodiments, the local activity recognizer 1760 automatically (without human input) labels the cluster using the majority of annotated actions. In other embodiments at block 1712, the local activity recognizer 1760 prompts the user to input the action type which can be considered as a label of the centroid of a new cluster. More particularly, the local activity recognizer 1760 prompts the user (or human expert providing weak supervision) to input an action annotation 1713 as a label for the cluster with a majority of the annotated actions.

Once each cluster is endowed with a label 1720, the training of the local activity recognizer 1760 is complete. The trained local activity recognizer 1760 performs activity recognition for actions that may provide higher accuracy and robustness compared to the VLM-based zero-shot activity recognition module 1660 in FIG. 16. Further, trained local activity recognizer 1760 may reduce the operational cost and complexity by skipping block 1710, as there is not a need to prompt the VLM each time an action is performed.

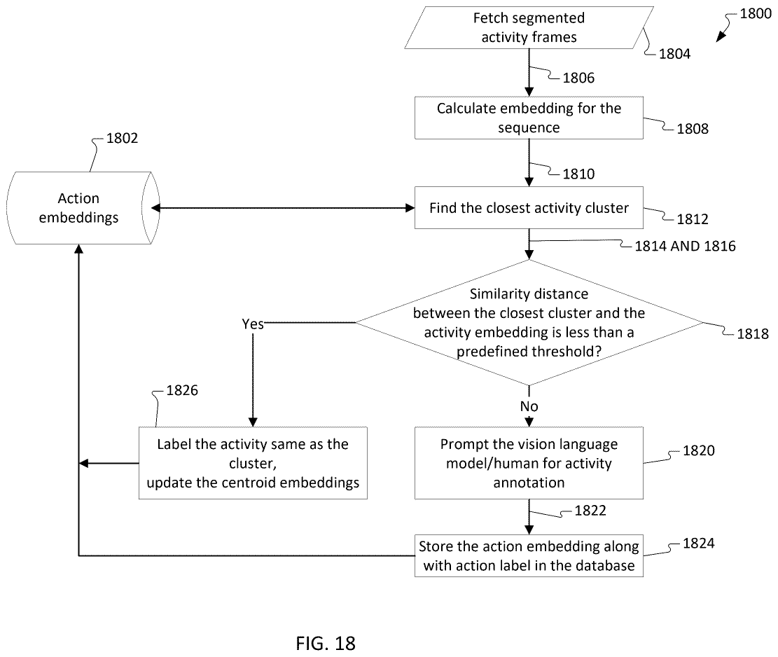

FIG. 18 illustrates a process 1800 for retraining the local nominal-shot activity recognizer based on an unseen class in accordance with an embodiment of this disclosure. The embodiment of the process 1800 shown in FIG. 18 is for illustration only, and other embodiments could be used without departing from the scope of this disclosure.

Both the process 1800 of FIG. 18 and the process 1700 of FIG. 17 provide one-shot/few-shot activity recognition. As an example, the local nominal-shot activity recognizer undergoing the process 1800 can be the activity recognizer 1760 of FIG. 17 or a different nominal-shot activity recognizer. For simplicity, the process 1800 is described as being performed by the processor 120 of FIG. 1. The process 1800 utilizes a database 1802 of action embeddings, which can be the same as or similar to the embeddings 1714 generated at block 1704 of FIG. 17.

The process 1800 to infer a user action can begin at block 1804 that includes retrieving a set of activity frames 1806 that have been segmented from non-activity frames. At block 1808, the processor 120 calculates a current embedding 1810 from the sequence of respective poses corresponding to the set of activity frames 1806. For example, the processor 120 can obtain the embedding for the sequence of poses by combining the embedding of all the frames that are part of the set of activity frames 1806. The processor 120 can perform average pooling the calculate the single embedding 1810 for the current set of activity frames 1806.

At block 1812, the processor 120 identifies a closest activity cluster 1814 from the database 1802 that has a greatest cosine similarity 1816 with the current embedding 1810. Here, the processor 120 can find the distance between the current embedding 1810 of the set of activity frames 1806 and the already existing embeddings of the centroids corresponding to different actions stored in the database 1802. These existing centroid embeddings are stored in the vector database 1802. As a distance metric, cosine distance or Euclidian distance between the embedded vectors can be used.

At block 1818, the processor 120 determines whether the greatest cosine similarity 1816 is less than a predefined similarity threshold. In response to a determination that the greatest cosine similarity 1816 is not less than the similarity threshold, it is determined that the processor 120 has encountered unseen activity that corresponds to an unseen, new action, then the method 1900 proceeds to block 1820 followed by block 1824. At block 1820, the processor 120 prompts the user or the VLM to input or generate, as the label for the inferred user action, an action annotation 1822 for the sequence of respective poses corresponding to the segmented set of activity frames 1806. At block 1824, the processor 120 adds, into the database 1802, the current embedding 1810 in correlation with the action annotation 1822 as label for the inferred user action.

Alternatively, in response to a determination that the greatest cosine similarity 1816 is less than the similarity threshold, the method 1900 proceeds to block 1826 because there is an inference can be that the action has been recognized correctly and that the current embedding 1810 can be assigned the same label as closest centroid 1814.

At block 1826, the processor 120 determines labels of the set of activity frames 1806 with the same label of the closest activity cluster 1814 and updates the centroid embeddings in the database 1802. Updating the centroid embedding can include adding the current embedding 1810 to the closest activity cluster 1814, and recalculating the centroid.

In summary, if a label for the activity already exists in the database 1802 of action embeddings, then the processor 120 simply updates the centroid of the labeled activity using the current activity embedding. But if the activity (i.e., sequence of poses corresponding to the set of activity frames 1806) does not exist in the database 1802, then the processor 120 adds the activity embedding 1810 as the centroid of a new cluster. In a deployment scenario referred to as “in the wild,” the activity that a human performed may not belong to any of the already labeled activities stored in the database 1802. In such cases, it may be advantageous to perform one-shot/few-shot classification. The process 1800 uses either user input or a VLM when a new sequence of poses activity or new action is identified.

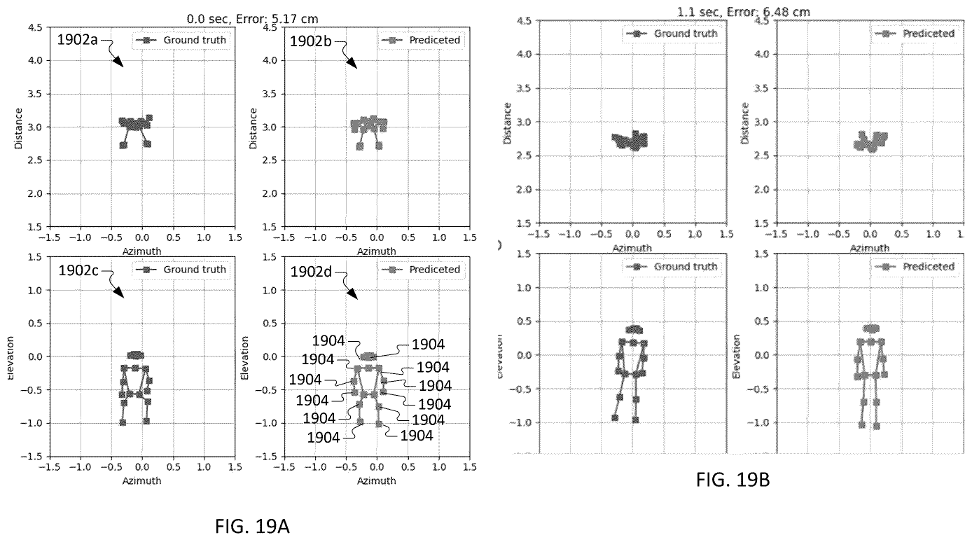

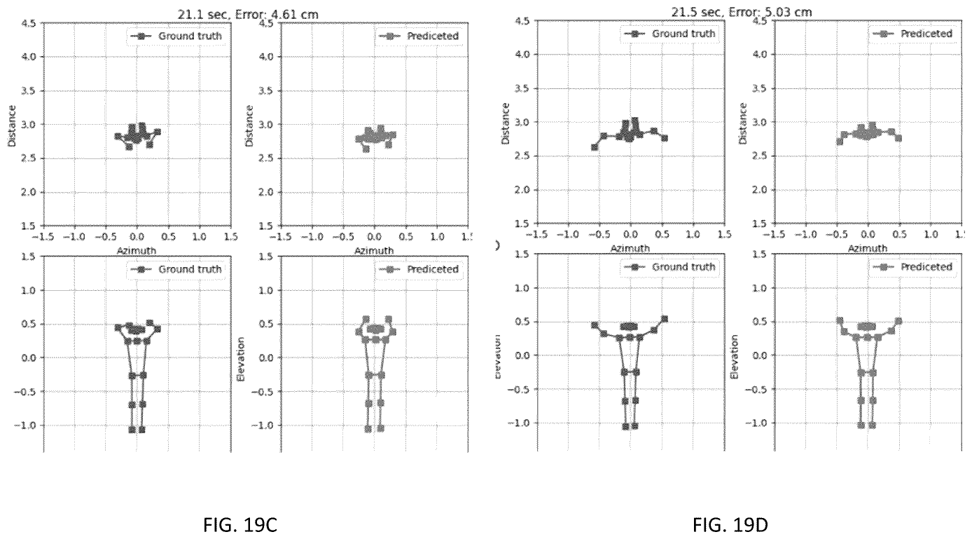

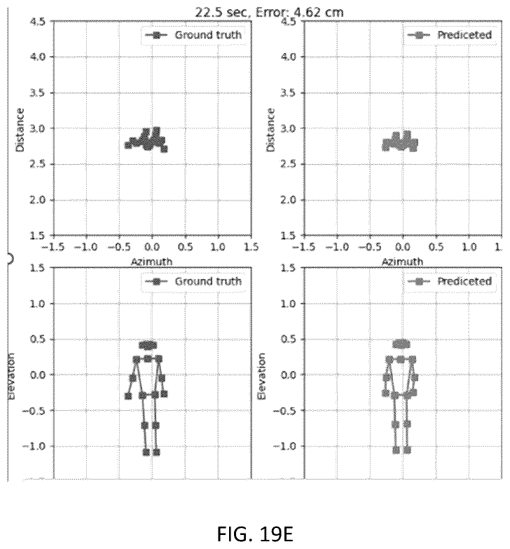

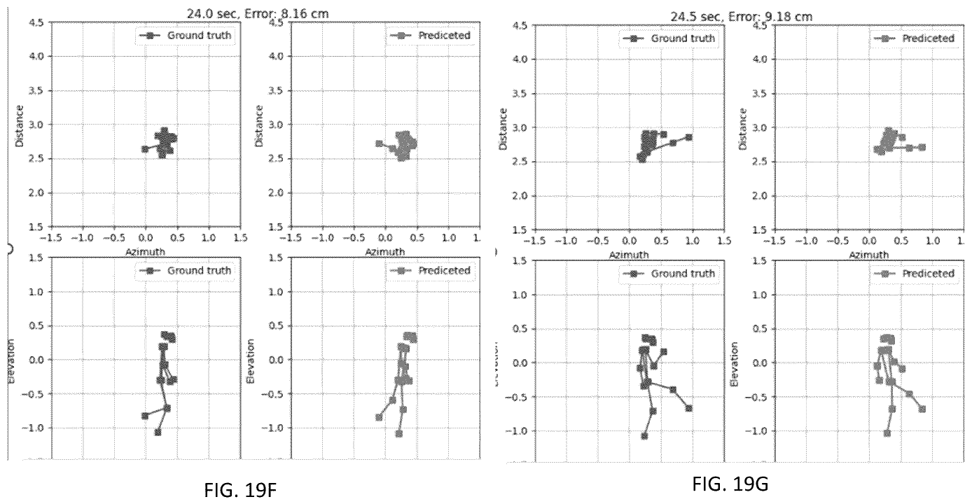

FIGS. 19A-19G illustrate examples of a plot of a ground truth skeleton and a corresponding plot of a radar-based predicted skeleton in accordance with an embodiment of this disclosure. More particularly, FIGS. 19A-19G are screenshots from a video in which a top-view plot and front-view plot of a ground truth skeleton are compared to top-view plot and front-view plot of a plot of a radar-based predicted skeleton. The ground truth plot can be generated based on an image data from a camera, and the radar-based prediction skeleton can be simultaneously generated by the system 800 of FIG. 8 where the radar field of view and camera field of view overlap. The examples of the plots shown in FIGS. 19A-19G are for illustration only, and other embodiments could be used without departing from the scope of this disclosure. Each of the plots of a radar-based predicted skeleton in FIGS. 19A-19G is a set of spatial relationships among the set of different human body parts (joints) 1904 at the current frame.

Referring to FIG. 19A, the video screenshot corresponds to a radar frame at timestamp 0.0 seconds when the person is in a sitting pose. This video screenshot shows a 2×2 array of plots that includes a top-view plot of a ground truth skeleton 1902a that is compared to a top-view plot of a radar-based predicted skeleton 1902b. Further, the video screenshot shows a front-view plot of a ground truth skeleton 1902c that is compared to a front-view plot of a radar-based predicted skeleton 1902d. The avoid duplicate descriptions, the 2×2 array of plots in FIGS. 19B-19G have the same arrangement.

Referring to FIG. 19B, the video screenshot corresponds to a radar frame at timestamp 1.1 seconds when the person is in a standing pose. FIGS. 19A-19B correspond to a sit-to-stand action that starts with the sitting pose, includes frames corresponding to the person rising, and ends at the standing pose. The time duration and changes of respective body part speeds from 0.1 to 1.1 seconds timestamps can be learned as temporal variations of the different human body parts across multiple time instances.

FIGS. 19C, 19D, and 19E correspond to a shoulder flexion-to-extension action that starts with a shoulder flexion pose at FIG. 19C, includes frames decreasing the angle of shoulder flexion such as FIG. 19D, and ends at the neutral shoulder pose at FIG. 19D. The radar frames can be at timestamps 21.1, 21.5, and 22.5 seconds, respectively for FIGS. 19C, 19D, and 19E. The time duration and velocity changes for this shoulder flexion-to-extension action can be learned as temporal variations of the different human body parts across multiple time instances.

FIGS. 19F and 19G correspond to a punt action that starts with a knee flexion pose at FIG. 19F, includes frames decreasing the angle of knee flexion and increasing angle of knee extension, and ends at a hip extension knee flexion pose at FIG. 19G. The start and end radar frames can be at timestamps 24.0 and 24.5 seconds, respectively for FIGS. 19F and 19G.

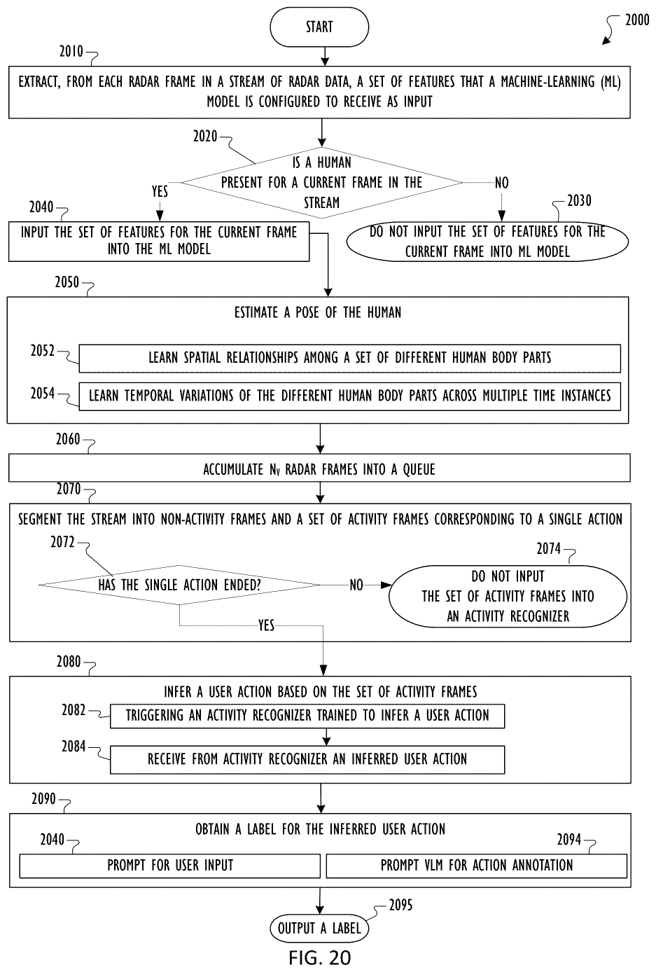

FIG. 20 illustrates a method 2000 for human pose estimation and activity recognition using mmWave radar in accordance with an embodiment of this disclosure. The embodiment of the method 2000 shown in FIG. 20 is for illustration only, and other embodiments could be used without departing from the scope of this disclosure. The method 2000 is implemented by an electronic device, such as the electronic device 101 of FIG. 1 or the electronic device 200 of FIG. 2. More particularly, the method 2000 could be performed by a processor 120, 240 of the electronic device 101, 200 executing the application 127, 262. For ease of explanation, the method 2000 is described as being performed by the processor 120 implementing the system 800 of FIG. 8.

In block 2010, the processor 120 (using the feature extractor 810) extracts, from each radar frame in a stream of radar data, a set of features that a machine-learning (ML) model is configured to receive as input.

In block 2020, the processor 120 (using the presence detector 820) determines whether a human is present for a current frame in the stream based on a range profile of the current frame. The procedure of block 2020 can be the same as the procedure at block 840.

At block 2030, in response to a determination that a human is not present in the radar field of view for the current frame, the system 800 does not input the set of features 822 for the current frame into the ML model. The ML model can be the HPE 1000, 1100, or 1300 of FIG. 10, 11, or 12. The procedure of block 2030 can be a response to the determination 842 of FIG. 8.

In response to a determination that the human is present for the current frame, the method 2000 proceeds to block 2040 followed by blocks 2050 then block 2060. At block 2040, the processor 120 inputs the set of features for the current frame into the ML model of the HPE 850.

At block 2050, the ML model of the HPE 850 estimates a pose 852 of the human. The ML model of the HPE 850 configured to estimate a pose 852 of the human based on learned spatial relationships among a set of different human body parts 1904 and learned temporal variations of the different human body parts across multiple time instances. The pose 852 of the human includes a set of spatial relationships among the set of different human body parts at the current frame. For example, each of the plots of a radar-based predicted skeleton in FIGS. 19A-19G is a set of spatial relationships among the set of different human body parts at the current frame.

The procedure at block 2050 can include block 2052 at which the processor 120 learns spatial relationships among a set of different human body parts, and can include block 2054 at which the processor 120 learns temporal variations of the different human body parts across multiple time instances. Such learning 2053-2054 can include the procedure of generating a database of centroid embeddings at block 1704 of FIG. 17, and adding a new action the database 1802 at block 1824 of FIG. 18.

At block 2060, the processor 120 accumulates the current frame and past consecutive radar frames from the stream into a FIFO queue of Nᵥ. This queue 862 is used to determine whether the radar frames indicate that the user has started to perform any activities with a sufficient duration (Nᵥ frames) and with sufficiently close proximity to the radar and with sufficient speed to be considered a start of any sequence of poses. In other words, movement of the body associated with breathing or other vital signs could have insufficient speed to trigger the activity segmenter; and a fast twitch movement of the body could have insufficient duration to trigger the activity segmenter.

At block 2070, the processor 120 segments the stream into non-activity frames and a set of activity frames corresponding to a single action, based on motion features extracted from one or more queues (such as the queue of Nᵥ 862 within the data window of N_{w} 864).

Segmenting the stream accumulated within data window 864 can include block 2072 at which the processor 120 determines whether the single action has ended, and block 2074 at which the processor 120 refrains or does not input the set of activity frames 866 into an activity recognizer (thereby returning the method 2000 to block 2010 to iterate for a next frame) based on a determination that the single action is ongoing and has not yet ended. The procedure at block 2072 can be the same as the procedure of block 870 of FIG. 8.

The procedure block 2080 for inferring a user action based on the set of activity frames includes block 2062, at which the processor 120 triggers an activity recognizer that is trained to infer a user action based on a sequence of respective poses of the human corresponding to the set of activity frames. The procedure block 2080 for inferring the user action includes receiving, from the activity recognizer, an inferred user action. The inferred user action can be the zero-shot response 1620 of FIG. 16, the nominal-shot response that is the label output 1720 of FIG. 17, or the label assigned at block 1824 or 1826 of FIG. 18.

At block 2090, the processor 120 (using the activity recognition module 880) obtains a label for the inferred user action. To obtain the label, the processor 120 can prompt the user for user input of an action annotation to be used as the label at block 2092, or can automatically prompt a VLM for an action annotation to be used as the label at block 2094.

At block 2095, the processor 120 outputs the label for the inferred user action. The procedure at block 2095 can be the same as the procedure of block 890. The video corresponding to FIGS. 19A-19G is an example of displaying one or more sequence of poses.

Although FIG. 20 illustrates an example process 2000 for method 2000 for human pose estimation and activity recognition using mmWave radar, various changes may be made to FIG. 20. For example, while shown as a series of steps, various steps in FIG. 20 could overlap, occur in parallel, occur in a different order, or occur any number of times. In some embodiments of block 2040, the processor 120 inputs a range-Doppler map (RDM), range-angle map (RAM), and range-elevation map (REM) extracted from the current frame. In such embodiments, the processor 120 extracts a point cloud from RDM, RAM, and REM; the processor 120 (using the ML model with an encoder) generates embeddings based on the point cloud; and the processor estimates the pose of the human based on the embeddings.

In some embodiments, the method 2000 further includes learning, by the ML model using spatial multi-head attention, the spatial relationships among the set of human body parts. In some embodiments, the method 2000 further includes learning, by the ML model using temporal attention, the temporal variations including a temporal relationship of motion of a respective human body part among the set of human body parts across multiple radar frames.

In some embodiments of block 2070, segmenting the stream comprises extracting a body part speed of at least some among the set of human body parts, as the motion features from each radar frame within the queue of Nᵥ; and segmenting activity frames from a sequence of N_{w} consecutive radar frames based on a comparison of a speed threshold and averages of the body part speeds extracted from each radar frame in the sequence of N_{w} consecutive radar frames, the sequence of N_{w} consecutive radar frames including the queue of Nᵥ.

In some embodiments of block 2080, inferring the user action is performed by the processor 120 (using the triggered activity recognizer) that inputs, into a VLM, the sequence of respective poses from the ML model and an optimized prompt; and receives, from the VLM, a generative action description as the label for the inferred user action.

In some embodiments, the method 2000 includes training the activity recognizer using clustering-based activity recognition algorithm for labeling a set of segmented actions, for example, using the process 1700 of FIG. 17. To perform this training process, the processor 120 receives a training dataset of segmented actions in which each segmented action includes a sequence of poses corresponding to a set of activity frames. The processor 120 generate embeddings for the sequences of poses in the training dataset and storing the embeddings in an action embeddings database; and clustering the sequences of poses in the training dataset, thereby generating a set of clusters. For each respective cluster among the set of clusters, the processor 120 prompts a VLM for action identification of selected samples from the respective cluster. Each sample being one of the sequences of poses. For each respective cluster among the set of clusters, the processor 120 labels each of the selected samples with an action annotation; and labels the respective cluster with one from among an action annotation input from a human or a majority action annotation from among the action annotations that labeled the selected samples.

In some embodiments the procedure at block 2080 includes the process 1800 in FIG. 18. The processor 120 utilizes a trained activity recognizer for inferring the user action by calculating a current embedding from the sequence of respective poses of the human corresponding to the set of activity frames; and identifying a closest activity cluster from the database that has a greatest cosine similarity with the current embedding. The processor 120 identifies a closest activity cluster from the database that has a greatest cosine similarity with the current embedding. The processor 120 labels the segmented set of activity frames with a label for the closest activity cluster, in response to a determination that the greatest cosine similarity is less than a similarity threshold. In response to a determination that the greatest cosine similarity is not less than a similarity threshold: the processor 120 prompts the user or the VLM to input or generate, as the label for the inferred user action, an action annotation for the sequence of respective poses of the human corresponding to the segmented set of activity frames. In response to a determination that the greatest cosine similarity is not less than a similarity threshold: the processor 120 adds, into the database, the current embedding in correlation with the label for the inferred user action.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method comprising:
extracting, from each radar frame in a stream of radar data, a set of features that a machine-learning (ML) model is configured to receive as input;
determining whether a human is present for a current frame in the stream based on a range profile of the current frame;
in response to a determination that the human is present for the current frame:
inputting the set of features for the current frame into the ML model that is configured to estimate a pose of the human based on learned spatial relationships among a set of different human body parts and a learned temporal variations of the different human body parts across multiple time instances, wherein the pose of the human includes a set of spatial relationships among the set of different human body parts at the current frame; and
accumulating the current frame and past consecutive radar frames from the stream into a queue of Nᵥ;
segmenting the stream into non-activity frames and a set of activity frames corresponding to a single action, based on motion features extracted from the queue;
triggering an activity recognizer that is trained to infer a user action based on a sequence of respective poses of the human corresponding to the set of activity frames; and
obtaining and outputting a label for the inferred user action.

2. The method of claim 1, wherein inputting the set of features for the current frame into the ML model comprises inputting a range-Doppler map (RDM), range-angle map (RAM), and range-elevation map (REM) extracted from the current frame.

3. The method of claim 2, further comprising:
extracting a point cloud from RDM, RAM, and REM;
generating, by the ML model using an encoder, embeddings based on the point cloud; and
estimating the pose of the human based on the embeddings.

4. The method of claim 1, further comprising training the ML model by:
learning, by the ML model using spatial multi-head attention, the spatial relationships among the set of human body parts; and
learning, by the ML model using temporal attention, the temporal variations including a temporal relationship of motion of a respective human body part among the set of human body parts across multiple radar frames.

5. The method of claim 1, wherein segmenting the stream comprises:
extracting a body part speed of at least some among the set of human body parts, as the motion features from each radar frame within the queue of Nᵥ; and
segmenting activity frames from a sequence of N_{w} consecutive radar frames based on a comparison of a speed threshold and averages of the body part speeds extracted from each radar frame in the sequence of N_{w} consecutive radar frames, the sequence of N_{w} consecutive radar frames including the queue of Nᵥ.

6. The method of claim 1, further comprising inferring, by the triggered activity recognizer, the user action by:
inputting, into a vision language model, the sequence of respective poses from the ML model and an optimized prompt; and
receiving, from the vision language model, a generative action description as the label for the inferred user action.

7. The method of claim 1, further comprising training the activity recognizer using clustering-based activity recognition algorithm for labeling a set of segmented actions, by:
receiving a training dataset of segmented actions in which each segmented action includes a sequence of poses corresponding to a set of activity frames;
generating embeddings for the sequences of poses in the training dataset and storing the embeddings in an action embeddings database;
clustering the sequences of poses in the training dataset, thereby generating a set of clusters;
for each respective cluster among the set of clusters:
prompting a vision language model for action identification of selected samples from the respective cluster, each sample being one of the sequences of poses;
labeling each of the selected samples with an action annotation; and
labeling the respective cluster with one from among:
an action annotation input from a human; or
a majority action annotation from among the action annotations that labeled the selected samples.

8. The method of claim 7, further comprising inferring, by the triggered activity recognizer, the user action by:
calculating a current embedding from the sequence of respective poses of the human corresponding to the set of activity frames;
identifying a closest activity cluster from the database that has a greatest cosine similarity with the current embedding;
labeling the segmented set of activity frames with a label for the closest activity cluster, in response to a determination that the greatest cosine similarity is less than a similarity threshold; and
in response to a determination that the greatest cosine similarity is not less than a similarity threshold:
prompting the user or the vision language model to input or generate, as the label for the inferred user action, an action annotation for the sequence of respective poses of the human corresponding to the segmented set of activity frames; and
adding, into the database, the current embedding in correlation with the label for the inferred user action.

9. A system comprising:
a transceiver; and
a processor operably connected to the transceiver and configured to:
extract, from each radar frame in a stream of radar data, a set of features that a machine-learning (ML) model is configured to receive as input;
determine whether a human is present for a current frame in the stream based on a range profile of the current frame;
in response to a determination that the human is present for the current frame:
input the set of features for the current frame into the ML model that is configured to estimate a pose of the human based on learned spatial relationships among a set of different human body parts and a learned temporal variations of the different human body parts across multiple time instances, wherein the pose of the human includes a set of spatial relationships among the set of different human body parts at the current frame; and
accumulate the current frame and past consecutive radar frames from the stream into a queue of Nᵥ;
segment the stream into non-activity frames and a set of activity frames corresponding to a single action, based on motion features extracted from the queue;
trigger an activity recognizer that is trained to infer a user action based on a sequence of respective poses of the human corresponding to the set of activity frames; and
obtain and output a label for the inferred user action.

10. The system of claim 9, wherein inputting the set of features for the current frame into the ML model comprises inputting a range-Doppler map (RDM), range-angle map (RAM), and range-elevation map (REM) extracted from the current frame.

11. The system of claim 10, wherein the processor is further configured to:
extract a point cloud from RDM, RAM, and REM;
generate, by the ML model using an encoder, embeddings based on the point cloud; and
estimate the pose of the human based on the embeddings.

12. The system of claim 9, wherein the processor is further configured to train the ML model, wherein to train the ML model, the processor is configured to:
learn, by the ML model using spatial multi-head attention, the spatial relationships among the set of human body parts; and
learn, by the ML model using temporal attention, the temporal variations including a temporal relationship of motion of a respective human body part among the set of human body parts across multiple radar frames.

13. The system of claim 9, wherein to segmenting the stream, wherein the processor is further configured to:
extract a body part speed of at least some among the set of human body parts, as the motion features from each radar frame within the queue of Nᵥ; and
segment activity frames from a sequence of N_{w} consecutive radar frames based on a comparison of a speed threshold and averages of the body part speeds extracted from each radar frame in the sequence of N_{w} consecutive radar frames, the sequence of N_{w} consecutive radar frames including the queue of Nᵥ.

14. The system of claim 9, to infer the user action, wherein the processor is further configured to use the triggered activity recognizer to:
input, into a vision language model, the sequence of respective poses from the ML model and an optimized prompt; and
receive, from the vision language model, a generative action description as the label for the inferred user action.

15. The system of claim 9, wherein the processor is further configured to train the activity recognizer using clustering-based activity recognition algorithm for labeling a set of segmented actions,
wherein to train the activity recognizer, the processor is further configured to:
receive a training dataset of segmented actions in which each segmented action includes a sequence of poses corresponding to a set of activity frames;
generate embeddings for the sequences of poses in the training dataset and storing the embeddings in an action embeddings database;
cluster the sequences of poses in the training dataset, thereby generating a set of clusters;
for each respective cluster among the set of clusters:
prompt a vision language model for action identification of selected samples from the respective cluster, each sample being one of the sequences of poses;
label each of the selected samples with an action annotation; and
label the respective cluster with one from among:
an action annotation input from a human; or
a majority action annotation from among the action annotations that labeled the selected samples.

16. The system of claim 15, wherein to infer the user action by using the triggered activity recognizer, the processor is further configured:
calculate a current embedding from the sequence of respective poses of the human corresponding to the set of activity frames;
identify a closest activity cluster from the database that has a greatest cosine similarity with the current embedding;
label the segmented set of activity frames with a label for the closest activity cluster, in response to a determination that the greatest cosine similarity is less than a similarity threshold; and
in response to a determination that the greatest cosine similarity is not less than a similarity threshold:
prompt the user or the vision language model to input or generate, as the label for the inferred user action, an action annotation for the sequence of respective poses of the human corresponding to the segmented set of activity frames; and
add, into the database, the current embedding in correlation with the label for the inferred user action.

17. A non-transitory computer readable medium embodying a computer program, the computer program comprising computer readable program code that when executed causes at least one processor to:
extract, from each radar frame in a stream of radar data, a set of features that a machine-learning (ML) model is configured to receive as input;
determine whether a human is present for a current frame in the stream based on a range profile of the current frame;
in response to a determination that the human is present for the current frame:
input the set of features for the current frame into the ML model that is configured to estimate a pose of the human based on learned spatial relationships among a set of different human body parts and a learned temporal variations of the different human body parts across multiple time instances, wherein the pose of the human includes a set of spatial relationships among the set of different human body parts at the current frame; and
accumulate the current frame and future consecutive radar frames from the stream into a queue of Nᵥ;
segment the stream into non-activity frames and a set of activity frames corresponding to a single action, based on motion features extracted from the queue;
trigger an activity recognizer that is trained to infer a user action based on a sequence of respective poses of the human corresponding to the set of activity frames; and
obtain and output a label for the inferred user action.

18. The non-transitory computer readable medium of claim 17, wherein the program code that when executed causes the at least one processor to input a range-Doppler map (RDM), range-angle map (RAM), and range-elevation map (REM) extracted from the current frame.

19. The non-transitory computer readable medium of claim 18, wherein the program code that when executed causes the at least one processor to:
extract a point cloud from RDM, RAM, and REM;
generate, by the ML model using an encoder, embeddings based on the point cloud; and
estimate the pose of the human based on the embeddings.

20. The non-transitory computer readable medium of claim 17, wherein the program code that when executed causes the at least one processor to segment the stream further comprise program code that when executed causes the at least one processor to:
extract a body part speed of at least some among the set of human body parts, as the motion features from each radar frame within the queue of Nᵥ; and
segment activity frames from a sequence of N_{w} consecutive radar frames based on a comparison of a speed threshold and averages of the body part speeds extracted from each radar frame in the sequence of N_{w} consecutive radar frames, the sequence of N_{w} consecutive radar frames including the queue of Nᵥ.
